(19) United States
(12) Patent Application Publication
(10) Pub. No.: US 2020/0041885 A1
(43) Pub. Date: Feb. 6, 2020

(54) LIGHT CONCENTRATOR MODULE

(71) Applicant: SIGNIFY HOLDING B.V., EINDHOVEN (NL)

(72) Inventors: MARTINUS PETRUS JOSEPH PEETERS, WEERT (NL); REMY CYRILLE BROERSMA, EINDHOVEN (NL); ADRIANUS JOHANNES STEPHANUS MARIA DE VAAN, 'S-HERTOGENBOSCH (NL)

(21) Appl. No.: 16/484,701

(22) PCT Filed: Feb. 6, 2018
(86) PCT No.: PCT/EP2018/052858

§ 371 Date: Aug. 8, 2019

(30) Foreign Application Priority Data
Feb. 17, 2017 (EP) 17156761.3

(51) Int. Cl. G03B 21/20; F21K 9/61; F21S 41/24; F21S 43/237; F21S 41/148; F21K 9/64; F21S 41/125

(52) U.S. Cl. CPC G03B 21/204; F21K 9/61; G03B 21/208; F21S 41/125; F21S 43/237; F21S 41/148; F21K 9/64; F21S 41/24

(57) ABSTRACT

The invention provides a lighting device (1) comprising a beam shaping assembly (3240) comprising two light transmissive beam shaping elements (3250), each beam shaping element (3250) having a first end window (3251) and a second end window (3252), larger than the first end window (3251), with the beam shaping element (3250) tapering from the second end window (3252) to the first end window (3251), wherein the two light transmissive beam shaping elements (3250) are configured with the second end windows (3252) facing each other, and wherein an optical filter element (1021,2021) is configured between the two light transmissive beam shaping elements (3250), and wherein the optical filter element (1021,2021) comprises a dichroic filter, wherein the beam shaping assembly may be configured between two light transmissive elements or between a light source and a light transmissive element.

### FIELD OF THE INVENTION

The invention relates to a lighting device, such as for use in a projector or for use in stage lighting. The invention further relates to a spot lighting system or an image projection system comprising such lighting device.

### BACKGROUND OF THE INVENTION

Luminescent rods are known in the art. WO2006/054203, for instance, describes a light emitting device comprising at least one LED which emits light in the wavelength range of >220 nm to <550 nm and at least one conversion structure placed towards the at least one LED without optical contact, which converts at least partly the light from the at least one LED to light in the wavelength range of >300 nm to ≤1000 nm, characterized in that the at least one conversion structure has a refractive index n of >1.5 and <3 and the ratio A:E is >2:1 and <50000:1, where A and E are defined as follows: the at least one conversion structure comprises at least one entrance surface, where light emitted by the at least one LED can enter the conversion structure and at least one exit surface, where light can exit the at least one conversion structure, each of the at least one entrance surfaces having an entrance surface area, the entrance surface area(s) being numbered A₁ . . . Aₙ and each of the at least one exit surface(s) having an exit surface area, the exit surface area(s) being numbered E₁ . . . Eₙ and the sum of each of the at least one entrance surface(s) area(s) A being A=A₁+A₂ . . . +Aₙ and the sum of each of the at least one exit surface(s) area(s) E being E=E₁+E₂ . . . +Eₙ.

### SUMMARY OF THE INVENTION

High brightness light sources are interesting for various applications including spots, stage-lighting, headlamps and digital light projection, etc., but also for retail or museum lighting. For this purpose, it is possible to make use of so-called light concentrators where shorter wavelength light is converted to longer wavelengths in a highly transparent luminescent material. A rod of such a transparent luminescent material can be illuminated by LEDs to produce longer wavelengths within the rod. Converted light which will stay in the luminescent material, such as a (trivalent cerium) doped garnet, in the waveguide mode and can then be extracted from one of the (smaller) surfaces leading to an intensity gain.

In embodiments, the light concentrator may comprise a rectangular bar (rod) of a phosphor doped, high refractive index garnet, capable to convert blue light into green light and to collect this green light in a small étendue output beam. The rectangular bar may have six surfaces, four large surfaces over the length of the bar forming the four side walls, and two smaller surfaces at the end of the bar, with one of these smaller surfaces forming the “nose” where the desired light is extracted.

Under e.g. blue light radiation, the blue light excites the phosphor, after the phosphor start to emit green light in all directions, assuming some cerium comprising garnet applications. Since the phosphor is embedded in—in general—a high refractive index bar, a main part of the converted (green) light is trapped into the high refractive index bar and wave guided to the nose of the bar where the (green) light may leave the bar. The amount of (green) light generated is proportional to the amount of blue light pumped into the bar. The longer the bar, the more blue LED's can be applied to pump phosphor material in the bar and the number of blue LED's to increase the brightness of the (green) light leaving at the nose of the bar can be used. The phosphor converted light, however, can be split into two parts.

A first part consist of first types of light rays that will hit the side walls of the bar under angles larger than the critical angle of reflection. These first light rays are trapped in the high refractive index bar and will traverse to the nose of the bar where it may leave as desired light of the system.

White light can be generated in different ways, such as with a blue pump and a green/yellow light emitting light concentrator (in general based on a cerium comprising garnet material). With the use of a dichroic cross, the green/yellow light, in combination with blue LED light and red LED light may provide white light. The green/yellow phosphor emission has a tail in the red part of the spectrum, overlapping with the red emission of the direct red LED. So a part of the phosphor emission is blocked by the dichroic mirror. In principle, it is also possible to make a high brightness spot by using a blue rod (pumped with UV LEDS) in combination with a yellow/green rod (low CRI, high CCT). By adding a third red rod, low CCT, higher CRI can be generated. The currently available materials for red are emitting at too short wavelengths to obtain high CRI warm/neutral white light (required for high-end spot applications).

Hence, it is an aspect of the invention to provide an alternative lighting device comprising a luminescent concentrator, which preferably further at least partly obviates one or more of above-described drawbacks and/or which may have a relatively higher efficiency. The present invention may have as object to overcome or ameliorate at least one of the disadvantages of the prior art, or to provide a useful alternative.

Therefore, the invention provides amongst others a lighting device (“device”) (comprising light sources configured to provide light source light and light transmissive bodies comprising a luminescent material (especially each comprising a different luminescent material) configured to convert at least part of the light source light into luminescent material light (thus having different spectral distributions)); wherein a first light source (configured to provide first light source light) and a first light transmissive body (comprising a first luminescent material) are configured to provide first luminescent material light, a second light source (configured to provide second light source light) and a second light transmissive body (comprising a second luminescent material) are configured to provide second luminescent material light spectrally different from first luminescent material light (see also above), and a third light source is configured to provide third light source light spectrally different from the first luminescent material light and the second luminescent material light; the third light source is configured upstream of the first light transmissive body, with the first light transmissive body being transmissive for at least part of the third light source light; the first light transmissive body is configured upstream of the second light transmissive body, with the second light transmissive body being transmissive for at least part of the third light source light that is transmitted through the first light transmissive body and transmissive for at least part of the first luminescent material light; and the second light transmissive body comprising a second radiation exit window configured to provide outcoupled light.

The device may further comprise one or more beam shaping assemblies, wherein each beam shaping assembly comprises two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein an optical filter element is configured between the two light transmissive beam shaping elements, wherein the optical filter element comprises a dichroic filter; wherein a beam shaping assembly is configured between the third light source and the first light transmissive body and/or wherein a beam shaping assembly is configured between the first light transmissive body and the second light transmissive body. In further specific embodiments, the lighting device may be configured to provide lighting device light comprising the outcoupled light, wherein in a first mode of the lighting device the lighting device light comprises white light comprising at least part of the third light source light, at least part of the first luminescent material light, and at least part of the second luminescent material light. Alternatively, in another mode of the lighting device, the different light sources may be addressed sequentially, thereby providing e.g. sequentially, red, green and blue light, which may appear to a user white. In yet further modes of the lighting device, colored light may be provided, such as red or blue, or one or more of green and yellow. However, other colors may also be provided.

With such lighting device, it is possible to create white light with a high intensity and a high color rendering index (CRI). Further, with such lighting device it may be possible to provide white light, but in embodiments also colored light. Further, with such beam shaping assembly it may be possible to reflect light back into the light transmissive body at one side, but transmit light from another source, such as a light source and/or another light transmissive body at another side of the beam shaping assembly. Further, such beam shaping assembly may further allow coupling of elements that have different cross-sections. Hence, the symmetry and/or dimensions of the first end windows of the two light transmissive beam shaping elements may be the same, but may also be different. However, especially the symmetry and dimensions of the second end windows of the two light transmissive beam shaping elements may essentially be the same.

Herein, the invention is especially described in relation to a first light transmissive body and a second light transmissive body (configured in series). However, the invention may also include embodiments with more than two light transmissive body (which may all be configured in series). Each light transmissive body may be pumped with light source light of light sources configured to irradiate the respective light transmissive body.

Hence, the invention provides amongst others a lighting device comprising light sources configured to provide light source light and light transmissive bodies comprising a luminescent material configured to convert at least part of the light source light into luminescent material light. In general, there are at least two different sets of light transmissive bodies and associated light sources.

Hence, a first light source is configured to provide first light source light. The term “first light source” may also refer to a plurality of first light sources.

The first light source and a first light transmissive body are configured to provide first luminescent material light. The luminescent material converts at least part of the first light source light into first luminescent material light. The first luminescent material light may especially escape from a radiation exit window (herein also indicated as first radiation exit window) from the first light transmissive body. The light transmissive body may especially be an elongated light transmissive body.

Further, a second light source is configured to provide second light source light. The term “second light source” may also refer to a plurality of second light sources. The second light source and first light source may provide essentially spectrally identical light source light. However, in general the second light source light and first light source light are different, such as blue and UV, or blue and violet, etc. Especially, assuming band emitters, such as LEDs (see also below) as light sources, the difference between the peak emissions of the first light sources and second light sources are at least 20 nm, such as at least 40 nm. However, in yet other embodiments, such as when e.g. using a green and a yellow luminescent material in two concentrators, the difference between the peak emissions may be small, or the peak emissions may even be essentially identical.

The second light source and second light transmissive body are configured to provide second luminescent material light spectrally different from first luminescent material light. In general, the color of the second luminescent material light and first luminescent material light are different, such as green and blue, or yellow and blue. The second luminescent material light may especially escape from a radiation exit window (herein also indicated as second radiation exit window) from the second light transmissive body. The light transmissive body may especially be an elongated light transmissive body.

The third light source is configured to provide third light source light spectrally different from the first luminescent material light and the second luminescent material light. The third light source is especially a solid state light source (see also below). The term “third light source” may also refer to a plurality of third light sources.

The third light source is configured upstream of the first light transmissive body, with the first light transmissive body being transmissive for at least part of the third light source light. This especially implies that at least part of the third light source light is received by the first light transmissive body, propagates through the first light transmissive body, and escapes from the first light transmissive body (at a radiation exit window of the first light transmissive body).

The third light source is configured to provide third light source light having an intensity in the red spectral part of the visible spectrum. For instance, the third light source may comprise a solid state light source configured to provide light source light having a peak wavelength selected from the range of 600-780 nm, such as especially in the range of 605-680 nm, like at least 610 nm.

In further specific embodiments, the third light source comprises a light emitting surface (such as a die of a solid state light source), wherein the light emitting surface is in physical contact with a light transmissive material. It appears that the light intensity that can be obtained with such solid state light source may be essentially higher than without such light transmissive material. The light transmissive material may be especially a glue, such as a silicone glue. Alternatively or additionally, a silicone gel or an optical fluid may be chosen. Hence, it appears that outcoupling with such light transmissive material may be higher than when the light emitting surface is in contact with a gas, such as air.

The phrase “spectrally different” especially indicate that the spectral distributions in the visible (and UV) are not identical. Especially, dominant wavelengths may be different, such as with at least 20 nm, such as at least 40 nm and/or color points may be differ, such as with at least 0.05 on the x scale and/or 0.05 on the y-scale of the CIE 1931 color diagram, even more especially at least 0.1 on the x scale and/or 0.1 on the y-scale.

Further, the term “transmissive” may especially refer to a transmission of at least 20%, such as at least 30%, like at least 50%, such as at least 70%, like at least 90%. For instance, the light transmissive bodies may especially be non-transmissive for the light source light of the related light sources, but may be transmissive for the luminescent material light generated by the respective light source. Further, the light transmissive bodies may be transmissive for the light of the third light source. The term “non-transmissive” may especially relate to a transmission of less than 20%, such as less than 10%, like less than 5%.

In specific embodiments, the lighting device may further comprise a first optical filter element configured downstream of the third light source and upstream of the first light transmissive body, wherein the first optical filter element is configured to transmit at least part of the third light source light and to reflect at least part of one or more of first light source light, first luminescent material light, second light source light, and second luminescent material light. In this way, e.g. green or yellow light may be reflected back into the first light transmissive body, and is thereby not lost. Further, in this way e.g. red light may be provided to the first light transmissive body, for propagation through the first light transmissive body to the second light transmissive body (etc.). Especially, the first optical filter element comprises a dichroic filter. Hence, the dichroic filter is especially transmissive for third light source light (arriving from a first direction of the dichroic filter) and is especially reflective for other light, especially one or more of the first luminescent material light and second luminescent material light, especially at least the first luminescent material light (arriving from a direction opposite of the first direction of the third light source light).

Herein, the term “dichroic filter” may also refer to a plurality of (different) dichroic filters.

As indicated above, in embodiments the first optical filter element may be configured to transmit at least part of the third light source light and to reflect at least part of one or more of first light source light, first luminescent material light, second light source light, and second luminescent material light. Hence, in specific embodiments the first optical filter element may be configured to transmit at least part of the third light source light and to reflect at least part of the light composed of first luminescent material light, second luminescent material light, first light source light and second luminescent material light.

Further, in embodiments the first light transmissive body is configured upstream of the second light transmissive body, with the second light transmissive body being transmissive for at least part of the third light source light that is transmitted through the first light transmissive body and transmissive for at least part of the first luminescent material light.

This especially implies that at least part of the third light source light that escapes from the first light transmissive body (especially from the radiation exit window of the first light transmissive body) is received by the second light transmissive body, propagates through the second light transmissive body, and escapes from the second light transmissive body (at a radiation exit window of the second light transmissive body).

This also especially implies that at least part of the first luminescent material light is received by the second light transmissive body, propagates through the second light transmissive body, and escapes from the second light transmissive body (at a radiation exit window of the second light transmissive body).

Hence, at the radiation exit window one or more of first light source light, second light source light, third light source light, first luminescent material light and second luminescent material light may escape, even more especially at least one or more of third light source light, first luminescent material light and second luminescent material light.

Therefore, the second light transmissive body comprises a second radiation exit window configured to provide outcoupled light. Especially, the second radiation exit window is configured for coupling out at least part of the third light source light transmitted through the first light transmissive body and the second light transmissive body, at least part of the first luminescent material light transmitted through the second light transmissive body, and at least part of the second luminescent material light.

As indicated above, the lighting device is configured to provide lighting device light comprising the outcoupled light, wherein in a first mode of the lighting device the lighting device light comprises white light comprising at least part of the third light source light, at least part of the first luminescent material light, and at least part of the second luminescent material light.

Instead of the term “first mode” also the term “first state” may be applied. The term “first state” indicates that there is at least one setting with essentially fixed conditions. In general, such first state is the state wherein the system is in use. Hence, the term “first state” may also refer to an “on state”. Would the system be controllable, then there may be different “on states”. In such embodiment, there may be a first state, a second state, and optionally further states. This may e.g. be the case for systems which can be in use with (continuously) variable conditions. Here, the term “condition” may e.g. refer to intensity of the light source light. Hence, the lighting device at least includes a first (on) state wherein white lighting device light is generated. In yet further embodiments, the lighting device light of the device is controllable, with one or more further modes, wherein e.g. also colored light may be provided. Control of the light characteristics may be executed with controlling the intensity of the light source light of the first light source(s), the second light source(s) and the third light source.

The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc. Beyond that, the term “controlling” and similar terms may additionally include monitoring. Hence, the term “controlling” and similar terms may include imposing behavior on an element and also imposing behavior on an element and monitoring the element.

Hence, in yet further embodiments the lighting device comprises a control system or may be functionally coupled to a control system. For instance, the invention may also provide a lighting system comprising the lighting device and a control system configured to control the lighting device.

The control system may further include or may be functionally coupled to a user interface. Examples of user interface devices include a manually actuated button, a display, a touch screen, a keypad, a voice activated input device, an audio output, an indicator (e.g., lights), a switch, a knob, a modem, and a networking card, among others. Especially, the user interface device may be configured to allow a user instruct the device or apparatus with which the user interface is functionally coupled by with the user interface is functionally comprised. The user interface may especially include a manually actuated button, a touch screen, a keypad, a voice activated input device, a switch, a knob, etc., and/or optionally a modem, and a networking card, etc. The user interface may comprise a graphical user interface. The term “user interface” may also refer to a remote user interface, such as a remote control. A remote control may be a separate dedicate device. However, a remote control may also be a device with an App configured to (at least) control the system or device or apparatus.

The lighting device may be configured to provide blue, green, yellow, orange, or red light, etc. (in further modes). If desired, monochromaticity may be improved using optical filter(s) (see also below).

Especially, the lighting device further comprising a beam shaping optical element optically coupled with the second radiation exit window, configured to beam shape the outcoupled light. In specific embodiments, the beam shaping optical element comprises a light transmissive body. Hence, the beam shaping optical element is especially light transmissive.

Here below, some information and embodiments are provided in relation to the beam shaping optical element that may be configured downstream of the second light transmissive body. However, the information and embodiments described below may also be relevant for beam shaping elements configured at other positions (see further below).

The beam shaping optical element may especially comprises a collimator used to convert (to “collimate”) the light beam into a beam having a desired angular distribution. Further, the beam shaping optical element especially comprises a light transmissive body comprising the radiation entrance window. Hence, the beam shaping optical element may be a body of light transmissive material that is configured to collimate the converter light from the luminescent body.

In specific embodiments, the beam shaping optical element comprises a compound parabolic like collimator, such as a CPC (compound parabolic concentrator). Hence, in yet a further embodiment, the lighting device further comprises a collimator configured downstream of the radiation exit window (of the highest order luminescent concentrator) and configured to collimate the converter light. Such collimator, like e.g. a CPC (compound parabolic concentrator), may be used to collimate the light escaping from the radiation exit window and to provide a collimated beam of light.

The beam shaping optical element may have cross section (perpendicular to an optical axis) with a shape that is the same as the cross-section of the luminescent body (perpendicular to the longest body axis (which body axis is especially parallel to a radiation input face). For instance, would the latter have a rectangular cross section, the former may also have such rectangular cross section, though the dimension may be different. Further, the dimension of the beam shaping optical element may vary over its length (as it may have a beam shaping function).

As indicated above, first radiation exit window is in optical contact with the radiation entrance window thereof. The term “optical contact” and similar terms, such as “optically coupled” especially mean that the light escaping the first radiation exit window surface area (A1) may enter the beam shaping optical element radiation entrance window with minimal losses (such as fresnel reflection losses or TIR (total internal reflection) losses) due to refractive index differences of these elements. The losses may be minimized by one or more of the following elements: a direct optical contact between the two optical elements, providing an optical glue between the two optical elements, preferably the optically glue having a refractive index higher that the lowest refractive index of the two individual optical elements, providing the two optical elements in close vicinity (e.g. at a distance much smaller than the wavelength of the light), such that the light will tunnel through the material present between the two optical elements, providing an optically transparent interface material between the two optical elements, preferably the optically transparent interface material having a refractive index higher that the lowest refractive index of the two individual optical elements, the optically transparent interface material might be a liquid or a gel or providing optical Anti Reflective coatings on the surfaces of the two individual optical elements.

Instead of the term “in optical contact” also the term “radiationally coupled” may be used. The term “radiationally coupled” especially means in this context that the luminescent body (i.e. the elongated light transmissive body) and the beam shaping optical element are associated with each other so that at least part of the radiation emitted by the luminescent body is received by the beam shaping optical element. The luminescent body and the beam shaping optical element, especially the indicated “windows” may in embodiments be in physical contact with each other or may in other embodiments in separated from each other with a (thin) layer of optical glue, e.g. having a thickness of less than about 1 mm, preferably less than 100 μm. Likewise, the light sources are radiationally coupled with the luminescent body, though in general the light sources are not in physical contact with the luminescent body (see also below). As the luminescent body is a body and as in general also the beam shaping optical element is a body, the term “window” herein may especially refer to side or a part of a side.

In embodiments, the first light transmissive body and the second light transmissive body are comprised by a single light transmissive body. For instance, a ceramic body may comprise a part with the first luminescent material and a part with the second luminescent material. There may be a concentration gradient between these two parts. In specific embodiments, the different luminescent materials may only be obtained with different concentration of an activator or luminescent ion.

In yet other embodiments, the first light transmissive body and the second light transmissive body are different light transmissive bodies. These bodies may touch each other or may be configured at a distance from each other. However, they do not belong to the same single light transmissive body. When using different light transmissive bodies, this also allows an arrangement of one or more optical components in between (see also below).

Herebelow, some information is provided in relation to the light transmissive bodies. Especially, these light transmissive bodies may be elongated, though this is not necessarily the case for one or both of the light transmissive bodies. The light transmissive body may also be indicated as “luminescent body”. For instance, the light transmissive body comprising luminescent material to provide blue luminescent material light may be short, and may e.g. be shorter than light transmissive bodies configured to generate (together with the associated light sources) light having a longer wavelength than blue. Especially for low CCT, the length of the light transmissive body may be small, especially smaller than of other light transmissive bodies.

The luminescent body may comprise one or more side faces, wherein the beam shaping optical element is configured to receive at the radiation entrance window at least part of the converter light that escapes from the one or more side faces.

This radiation may reach the entrance window via a gas, such as air directly. Additionally or alternatively, this radiation may reach the entrance window after one or more reflections, such as reflections at a mirror positioned nearby the luminescent body. Hence, in embodiments the lighting device may further comprise a first reflective surface, especially configured parallel to one or more side faces, and configured at a first distance (dl) from the luminescent body, wherein the first reflective surface is configured to reflect at least part of the converter light that escapes from the one or more side faces back into the luminescent body or to the beam shaping optical element. The space between the reflective surface and the one or more side faces comprises a gas, wherein the gas comprises air. The first distance may e.g. be in the range of 0.1 μm-20 mm, such as in the range of 1-10 mm, like 2 μm-10 mm.

The term “light concentrator” or “luminescent concentrator” is herein used, as one or more light sources irradiate a relative large surface (area) of the light converter, and a lot of converter light may escape from a relatively small area (exit window) of the light converter. Thereby, the specific configuration of the light converter provides its light concentrator properties. Especially, the light concentrator may provide Stokes-shifted light, which is Stokes shifted relative to the pump radiation. Hence, the term “luminescent concentrator” or “luminescent element” may refer to the same element, especially an elongated light transmissive body (comprising a luminescent material), wherein the term “concentrator” and similar terms may refer to the use in combination with one or more light sources and the term “element” may be used in combination with one or more, including a plurality, of light sources. When using a single light source, such light source may e.g. be a laser, especially a solid state laser (like a LED laser). The elongated light transmissive body comprises a luminescent material and can herein especially be used as luminescent concentrator. The elongated light transmissive body is herein also indicated as “luminescent body”. Especially, a plurality of light sources may be applied.

The light concentrator comprises a light transmissive body. The light concentrator is especially described in relation to an elongated light transmissive body, such as a ceramic rod or a crystal, such as a single crystal. However, these aspects may also be relevant for other shaped ceramic bodies or single crystals. In specific embodiments, the luminescent body comprises a ceramic body or single crystal.

The light transmissive body has light guiding or wave guiding properties. Hence, the light transmissive body is herein also indicated as waveguide or light guide. As the light transmissive body is used as light concentrator, the light transmissive body is herein also indicated as light concentrator. The light transmissive body will in general have (some) transmission of visible light in a direction perpendicular to the length of the light transmissive body. Without the activator (dopant) such as trivalent cerium, the transmission in the visible might be close to 100%.

The light transmissive body may have any shape, such as beam like or rod like, however especially beam like (cuboid like). However, the light transmissive body may also be disk like, etc. The light transmissive body, such as the luminescent concentrator, might be hollow, like a tube, or might be filled with another material, like a tube filled with water or a tube filled with another solid light transmissive medium. The invention is not limited to specific embodiments of shapes, neither is the invention limited to embodiments with a single exit window or outcoupling face. Below, some specific embodiments are described in more detail. Would the light transmissive body have a circular cross-section, then the width and height may be equal (and may be defined as diameter). Especially, however, the light transmissive body has a cuboid like shape, such as a bar like shape, and is further configured to provide a single exit window.

In a specific embodiment, the light transmissive body may especially have an aspect ratio larger than 1, i.e. the length is larger than the width. In general, the light transmissive body is a rod, or bar (beam), or a rectangular plate, though the light transmissive body does not necessarily have a square, rectangular or round cross-section. In general, the light source is configured to irradiate one of the longer faces (side edge), herein indicated as radiation input face, and radiation escapes from a face at a front (front edge), herein indicated as radiation exit window. Especially, in embodiments the solid state light source, or other light source, is not in physical contact with the light transmissive body. Physical contact may lead to undesired outcoupling and thus a reduction in concentrator efficiency. Further, in general the light transmissive body comprises two substantially parallel faces, the radiation input face and opposite thereof the opposite face. These two faces define herein the width of the light transmissive body. In general, the length of these faces defines the length of the light transmissive body. However, as indicated above, and also below, the light transmissive body may have any shape, and may also include combinations of shapes. Especially, the radiation input face has an radiation input face area (A), wherein the radiation exit window has a radiation exit window area (E), and wherein the radiation input face area (A) is at least 1.5 times, even more especially at least two times larger than the radiation exit window area (E), especially at least 5 times larger, such as in the range of 2-50,000, especially 5-5,000 times larger. Hence, especially the elongated light transmissive body comprises a geometrical concentration factor, defined as the ratio of the area of the radiation input faces and the area of the radiation exit window, of at least 1.5, such as at least 2, like at least 5, or much larger (see above). This allows e.g. the use of a plurality of solid state light sources (see also below). For typical applications like in automotive, digital projectors, or high brightness spot light applications, a small but high intense emissive surface is desired. This cannot be obtained with a single LED, but can be obtained with the present lighting device. Especially, the radiation exit window has a radiation exit window area (E) selected from the range of 1-100 mm². With such dimensions, the emissive surface can be small, whereas nevertheless high intensity may be achieved. As indicated above, the light transmissive body in general has an aspect ratio (of length/width). This allows a small radiation exit surface, but a large radiation input surface, e.g. irradiated with a plurality of solid state light sources. In a specific embodiment, the light transmissive body has a width (W) selected from the range of 0.5-100 mm. The light transmissive body is thus especially an integral body, having the herein indicated faces.

The generally rod shaped or bar shaped light transmissive body can have any cross sectional shape, but in embodiments has a cross section the shape of a square, rectangle, round, oval, triangle, pentagon, or hexagon. Generally the ceramic or crystal bodies are cuboid. In specific embodiments, the body may be provided with a different shape than a cuboid, with the light input surface having somewhat the shape of a trapezoid. By doing so, the light flux may be even enhanced, which may be advantageous for some applications. Hence, in some instances (see also above) the term “width” may also refer to diameter, such as in the case of a light transmissive body having a round cross section. Hence, in embodiments the elongated light transmissive body further has a width (W) and a height (H), with especially L>W and L>H. Especially, the first face and the second face define the length, i.e. the distance between these faces is the length of the elongated light transmissive body. These faces may especially be arranged parallel. Further, in a specific embodiment the length (L) is at least 2 cm, such as 4-20 cm.

Especially, the light transmissive body has a width (W) selected to absorb more than 95% of the light source light. In embodiments, the light transmissive body has a width (W) selected from the range of 0.03-4 cm, especially 0.05-2 cm, such as 0.1-1.5 cm, like 0.1-1 cm. With the herein indicated cerium concentration, such width is enough to absorb substantially all light generated by the light sources.

The light transmissive body may also be a cylindrically shaped rod. In embodiments the cylindrically shaped rod has one flattened surface along the longitudinal direction of the rod and at which the light sources may be positioned for efficient incoupling of light emitted by the light sources into the light transmissive body. The flattened surface may also be used for placing heatsinks. The cylindrical light transmissive body may also have two flattened surfaces, for example located opposite to each other or positioned perpendicular to each other. In embodiments the flattened surface extends along a part of the longitudinal direction of the cylindrical rod. Especially however, the edges are planar and configured perpendicular to each other.

The light transmissive body may also be a fiber or a multitude of fibers, for instance a fiber bundle, either closely spaced or optically connected in a transparent material. The fiber may be referred to as a luminescent fiber. The individual fiber may be very thin in diameter, for instance, 0.1 to 0.5 mm. The light transmissive body may also comprise a tube or a plurality of tubes. In embodiments, the tube (or tubes) may be filled with a gas, like air or another gas having higher heat conductivity, such as helium or hydrogen, or a gas comprising two or more of helium, hydrogen, nitrogen, oxygen and carbon dioxide. In embodiments, the tube (or tubes) may be filled with a liquid, such as water or (another) cooling liquid.

The light transmissive body as set forth below in embodiments according to the invention may also be folded, bended and/or shaped in the length direction such that the light transmissive body is not a straight, linear bar or rod, but may comprise, for example, a rounded corner in the form of a 90 or 180 degrees bend, a U-shape, a circular or elliptical shape, a loop or a 3-dimensional spiral shape having multiple loops. This provides for a compact light transmissive body of which the total length, along which generally the light is guided, is relatively large, leading to a relatively high lumen output, but can at the same time be arranged into a relatively small space. For example luminescent parts of the light transmissive body may be rigid while transparent parts of the light transmissive body are flexible to provide for the shaping of the light transmissive body along its length direction. The light sources may be placed anywhere along the length of the folded, bended and/or shaped light transmissive body.

Parts of the light transmissive body that are not used as light incoupling area or light exit window may be provided with a reflector. Hence, in an embodiment the lighting device further comprises a reflector configured to reflect luminescent material light back into the light transmissive body. Therefore, the lighting device may further include one or more reflectors, especially configured to reflect radiation back into the light transmissive body that escapes from one or more other faces than the radiation exit window. Especially, a face opposite of the radiation exit window may include such reflector, though in an embodiment not in physical contact therewith. Hence, the reflectors may especially not be in physical contact with the light transmissive body. Therefore, in an embodiment the lighting device further comprises an optical reflector (at least) configured downstream of the first face and configured to reflect light back into the elongated light transmissive body. Alternatively or additionally, optical reflectors may also be arranged at other faces and/or parts of faces that are not used to couple light source light in or luminescence light out. Especially, such optical reflectors may not be in physical contact with the light transmissive body. Further, such optical reflector(s) may be configured to reflect one or more of the luminescence and light source light back into the light transmissive body. Hence, substantially all light source light may be reserved for conversion by the luminescent material (i.e. the activator element(s) such as especially Ce³⁺) and a substantial part of the luminescence may be reserved for outcoupling from the radiation exit window. The term “reflector” may also refer to a plurality of reflectors.

The one or more reflectors may consist of a metal reflector, such as a thin metal plate or a reflective metal layer deposited on a substrate, such as e.g. glass. The one or more reflectors may consist of an optical transparent body containing optical structure to reflect (part) of the light such as prismatic structures. The one or more reflectors may consist of specular reflectors. The one or more reflectors may contain microstructures, such as prism structures or sawtooth structures, designed to reflect the lightrays towards a desired direction.

Preferably, such reflectors are also present in the plane where the light sources are positioned, such that that plane consist of a mirror having openings, each opening having the same size as a corresponding light source allowing the light of that corresponding light source to pass the mirror layer and enter the elongated (first) light transmissive body while light that traverses from the (first) light transmissive body in the direction of that plane receives a high probability to hit the mirror layer and will be reflected by that mirror layer back towards the (first) light transmissive body.

For further improving efficiency and/or for improving the spectral distribution several optical elements may be included like mirrors, optical filters, additional optics, etc. In specific embodiments, the lighting device may have a mirror configured at the first face configured to reflect light back into the elongated light transmissive body, and/or may have one or more of an optical filter, a (wavelength selective) mirror, a reflective polarizer, light extraction structures, and a collimator configured at the second face. At the second face the mirror may e.g. be a wavelength selective mirror or a mirror including a hole. In the latter embodiment, light may be reflected back into the body but part of the light may escape via the hole. Especially, in embodiments the optical element may be configured at a distance of about 0.01-1 mm, such as 0.1-1 mm from the body.

Downstream of the radiation exit window, optionally an optical filter may be arranged. Such optical filter may be used to remove undesired radiation. For instance, when the lighting device should provide red light, all light other than red may be removed. Hence, in a further embodiment the lighting device further comprises an optical filter configured downstream of the radiation exit window and configured to reduce the relative contribution of undesired light in the converter light (downstream of the radiation exit window). For filtering out light source light, optionally an interference filter may be applied.

As indicated above, the lighting device comprises a first light transmissive body and a second light transmissive body. Especially, these light transmissive bodies have essentially the same cross-sectional shape and dimensions. Likewise, especially the beam shaping element configured downstream of the second light transmissive body has essentially the same type of cross-sectional shape and the radiation entrance window may essentially also have the same dimensions as the radiation exit window of the second light transmissive body.

The first light transmissive body and the second light transmissive body may especially be configured “haid-tail”, with the “nose” of the first light transmissive body directed to the a part (“back” or “tail”) of the second light transmissive body configure opposite of the “nose” of this second light transmissive body.

Hence, the first light transmissive body and the second light transmissive body are specially configured in series.

Especially, the lighting device is based on the triband principle. However, this does not exclude the further use of one or more additional (solid state) light sources for admixing of light and/or the further use of one or more additional light transmissive bodies (comprising a luminescent material).

Hence, in embodiments one (or more) of the light transmissive bodies may be configured to provide one or more of green and yellow light, and one or more other light transmissive bodies may be configured to provide red blue light. Optionally, the third light source is also based on the use of a light transmissive body, but this embodiment will herein not further be elucidated.

The first light source is configured to provide blue first light source light, and the first light source and first light transmissive body are configured to provide first luminescent material light having an intensity in one or more of the green and yellow spectral part(s) of the visible spectrum. The second light source is configured to provide second light source light having an intensity in one or more of the UV and blue spectral part(s) of the visible spectrum, and the second light source and the second light transmissive body are configured to provide second luminescent material light having an intensity in the blue spectral part of the visible spectrum. The third light source is configured to provide red light source light. In this way, white light may be generated.

In specific embodiments the first light source is configured to provide blue first light source light, and the first light source and first light transmissive body are configured to provide first luminescent material light having an intensity in the spectral range of about 480-780 nm. Hence, at one or more wavelengths in this range, there will be light intensity, especially an intensity in one or more of the green and yellow spectral part(s) of the visible spectrum.

A problem with a dichroics may be the relative large angular distribution of rays that will hit the dichroic. Typically the dichroic will shift by ±50 nm if the angle of incidence changes by ±24°. For a dichroic between the blue and red, this may probably be a minor issue, since the emissions are more than 150 nm apart. A dichroic between green and red (or between blue and green) may not function optimally. A way to improve the dichroic function is to use e.g. two CPC components (head to tail, with a dichroic inbetween) in order to reduce the angular distribution of the light.

The lighting device comprises a beam shaping assembly comprising two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein the first optical filter element is configured between the two light transmissive beam shaping elements. The beam shaping elements per se are also described above in more detail. The increased cross-section of the beam shaping element (increased relative to the light transmissive body) may facilitate light extraction from the light transmissive body.

In specific embodiments, the two light transmissive beam shaping elements are not physically coupled. Hence, the beam shaping elements may not be directly in contact with each other. More especially, there may be a (small) air gap in between.

As indicated above, an optical filter element may be configured downstream of the third light source and upstream of the first light transmissive body. Additionally or alternatively, also an optical filter element may be configured between the first light transmissive body and the second light transmissive body.

Hence, in embodiments the lighting device may further comprise a second optical filter element configured downstream of the first light transmissive body and upstream of the second light transmissive body, wherein the second optical filter element is configured to transmit at least part of the third light source light and at least part of the first luminescent material light and to reflect at least part of one or more of the second light source light and the second luminescent material light.

As indicated above, the second optical filter element comprises a dichroic filter.

Hence, in yet further specific embodiments the lighting device may further comprise a beam shaping assembly comprising two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, wherein the second optical filter element is configured between the two light transmissive beam shaping elements. Hence, this beam shaping assembly may be configured between the first light transmissive body and the second light transmissive body.

In specific embodiments, the two light transmissive beam shaping elements are not physically coupled. Hence, the beam shaping elements may not be directly in contact with each other. More especially, there may be a (small) air gap in between.

In yet a further aspect, the invention also provides a lighting device comprising one or more light sources configured to provide light source light and a light transmissive body comprising a luminescent material configured to convert at least part of the light source light into luminescent material light; wherein a first light source, configured to provide first light source light, and a first light transmissive body are configured to provide first luminescent material light; wherein a third light source is configured to provide third light source light spectrally different from the first luminescent material light, wherein the third light source is configured upstream of the first light transmissive body, with the first light transmissive body being transmissive for at least part of the third light source light; and a beam shaping assembly comprising two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein an optical filter element is configured between the two light transmissive beam shaping elements, wherein the optical filter element especially comprises a dichroic filter; wherein a beam shaping assembly is configured between the third light source and the first light transmissive body. The first light transmissive body may comprise a first radiation exit window, from which first luminescent material light and/or third light source light may escape. Further, the first light transmissive body may comprise a first face and a second face, defining a length of the light transmissive body, wherein the second face may comprise the first radiation exit window.

In yet a further aspect, the invention provides a lighting device comprising light sources configured to provide light source light and light transmissive bodies comprising a luminescent material configured to convert at least part of the light source light into luminescent material light; wherein a first light source, configured to provide first light source light, and a first light transmissive body are configured to provide first luminescent material light; a second light source, configured to provide second light source light, and a second light transmissive body are configured to provide second luminescent material light spectrally different from first luminescent material light; wherein the first light transmissive body is configured upstream of the second light transmissive body, with the second light transmissive body being transmissive for at least part of the first luminescent material light; wherein the second light transmissive body comprising a second radiation exit window configured to provide outcoupled light; wherein a beam shaping assembly comprises two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein especially an optical filter element is configured between the two light transmissive beam shaping elements, wherein the optical filter element (especially comprises a dichroic filter; wherein a beam shaping assembly is configured between the first light transmissive body and the second light transmissive body. The first light transmissive body may comprise a first radiation exit window, from which first luminescent material light may escape. Further, the first light transmissive body may comprise a first face and a second face, defining a length of the light transmissive body, wherein the second face may comprise the radiation exit window. The second light transmissive body may also comprise a first radiation exit window, from which second luminescent material light and first luminescent material light may escape. Further, the second light transmissive body may comprise a first face and a second face, defining a length of the light transmissive body, wherein the second face may comprise the second radiation exit window.

A beam shaping assembly comprises two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein an optical filter element is configured between the two light transmissive beam shaping elements, wherein the optical filter element especially comprises a dichroic filter. Therefore, in embodiments the invention also provides a lighting device comprising a beam shaping assembly, wherein especially the beam shaping assembly may be configured between two light transmissive elements or between a light source and a light transmissive element. Such beam shaping assembly may also be used to optically couple to light transmissive elements that have different shapes. The first end windows of the beam shaping assembly may essentially match with the (different) faces of the light transmissive elements.

As indicated above, the lighting device may especially comprise three different types of light sources, such as one or more third light sources for red light, one or more first light sources for blue light and one or more second light sources for UV light. However, dependent upon the lighting device, also less than three different types of light sources or more than three different types of light sources may be applied. Aspects of the light sources in general are indicated below.

For instance, in an aspect the invention provides a light source optically coupled to a beam shaping assembly. For instance, the invention may provide as unit a (third) light source optically coupled with a beam shaping assembly. No further light source may be present.

In yet a further aspect, the invention provides two light transmissive elements (each comprising a (different) luminescent material), each optically coupled with one side (i.e. first end window) of a beam shaping assembly. For instance, one luminescent concentrator may be configured to provide blue luminescent material light, one may be configured to provide green luminescent material light and/or yellow luminescent material light. In further embodiments, one or more light sources may be optically coupled with one of the light transmissive elements and/or one or more might sources may optically be coupled with the other one of the light transmissive elements, for providing such luminescent material light. Hence, the invention also provides a beam shaping assembly configured between two luminescent concentrators.

In yet further embodiments, the invention provides two beam shaping elements configured between three luminescent concentrators, with between each set of two luminescent concentrators a beam shaping element. For instance, one luminescent concentrator may be configured to provide blue luminescent material light, one may be configured to provide green luminescent material light and/or yellow luminescent material light, and one may be configured to provide red luminescent material light. Further, one or more light sources may be configured to pump with light source light one or more light transmissive bodies of the respective luminescent concentrators, for providing such luminescent material light.

In yet further embodiments, two beam shaping elements may be configured between two luminescent concentrators and between a light source and a luminescent concentrator, respectively.

In some of the above examples, the beam shaping element including optical element, especially dichroic filter, may allow transmission of (luminescent material) light in one at least one direction for one of the (luminescent material) light types, while transmission of (luminescent material) light in one at least one direction for the other one of the (luminescent material) light types may be inhibited.

Further, in some embodiments one or more additional light sources may be applied, of which the light may essentially be transmitted through one or more light transmissive bodies.

As indicated above, embodiments of the lighting device may comprise a light source, especially a plurality of light sources to provide light source light that is at least partly converted by the light transmissive body, more especially the luminescent material of the light transmissive body, into converter light. The converted light can at least partially escape form the first radiation exit window, which is especially in optical contact with the beam shaping optical element, more especially the radiation entrance window thereof.

These plurality of light sources may be configured to provide light source light to a single side or face or to a plurality of faces; see further also below. When providing light to a plurality of faces, in general each face will receive light of a plurality of light sources (a subset of the plurality of light sources). Hence, in embodiments a plurality of light sources will be configured to provide light source light to a radiation input face. Also this plurality of light sources will in general be configured in a row. Hence, the light transmissive body is elongated, the plurality of light sources may be configured in a row, which may be substantially parallel to the axis of elongated of the light transmissive body. The row of light sources may have substantially the same length as the elongated light transmissive body. Hence, in the light transmissive body has a length (L) in the range of about 80-120% of the second length (L2) of the row of light sources; or the row of light sources has a length in the range of about 80-120% of the length of the light transmissive body.

Especially, the light sources are light sources that during operation emit (light source light) at least light at a wavelength selected from the range of 200-490 nm, especially light sources that during operation emit at least light at wavelength selected from the range of 400-490 nm, even more especially in the range of 440-490 nm (for the first light sources or the second light sources). Note that the third light source may e.g. emit in the red and the second light sources or the first light sources may emit in the UV (and/or violet). This light (of the first light sources and second light sources) may partially be used by the luminescent material. Hence, in a specific embodiment, one or more of the light source are configured to generate blue light.

In a specific embodiment, one or more light sources comprises solid state light sources (such as a LED or laser diode). The term “light source” may also relate to a plurality of light sources, such as e.g. 2-2000, such as 2-500, like 2-100, especially 4-80 (solid state) light sources, though many more light sources may be applied. The term “light source” may also relate to one or more light sources that are tailored to be applied for such light concentrating luminescent concentrators, e.g. one or more LED's having a long elongated radiating surface matching the long elongated light input surfaces of the elongated luminescent concentrator. Hence, the term LED may also refer to a plurality of LEDs. Hence, as indicated herein, the term “solid state light source” may also refer to a plurality of solid state light sources. In an embodiment (see also below), these are substantially identical solid state light sources, i.e. providing substantially identical spectral distributions of the solid state light source radiation. In embodiments, the solid state light sources may be configured to irradiate different faces of the light transmissive body. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB or comparable. Hence, a plurality of semiconductor light sources may be configured on the same substrate. In embodiments, a COB is a multi LED chip configured together as a single lighting module.

The lighting device comprises a plurality of light sources. Especially, the light source light of the plurality (m) of light sources have spectral overlap, even more especially, they are of the same type and provide substantial identical light (having thus substantial the same spectral distribution). Hence, the light sources may substantially have the same emission maximum (“peak maximum”), such as within a bandwidth of 10 nm, especially within 8 nm, such as within 5 nm (e.g. obtained by binning) However, in yet other embodiments, the lighting device may comprise a single light source, especially a solid state light source having a relatively large die. Hence, herein also the phrase “one or more light sources” may be applied.

The light sources are especially configured to provide a blue optical power (Wₒₚₜ) of at least 0.2 Watt/mm² to the light transmissive body, i.e. to the radiation input face(s). The blue optical power is defined as the energy that is within the energy range that is defined as blue part of the spectrum (see also below). Especially, the photon flux is in average at least 4.5*10¹⁷ photons/(s·mm²), such as at least 6.0*10¹⁷ photons/(s·mm²). Assuming blue (excitation) light, this may e.g. correspond to a blue power (Wₒₚₜ) provided to at least one of the radiation input faces of in average at least 0.067 Watt/mm² and 0.2 Watt/mm², respectively. Here, the term “in average” especially indicates an average over the area (of the at least one of the radiation input surfaces). When more than one radiation input surface is irradiated, then especially each of these radiation input surfaces receives such photon flux. Further, especially the indicated photon flux (or blue power when blue light source light is applied) is also an average over time.

In yet a further embodiment, especially for (DLP (digital light processing)) projector applications, the plurality of light sources are operated in pulsed operation with a duty cycle selected from the range of 10-80%, such as 25-70%.

In yet a further embodiment, especially for (LCD or DLP) projector applications using dynamic contrast technologies, such as e.g. described in WO0119092 or U.S. RE42,428 (E1), the plurality of light sources are operated in video signal content controlled PWM pulsed operation with a duty cycle selected from the range of 0.01-80%, such as 0.1-70%.

In yet a further embodiment, especially for (LCD or DLP) projector applications using dynamic contrast technologies, such as e.g. described in US patent WO0119092 or U.S. Pat. No. 6,631,995 (B2), the plurality of light sources are operated in video signal content controlled intensity modulated operation with intensity variations selected from the range of 0.1-100%, such as 2-100%.

The light concentrator may radiationally be coupled with one or more light sources, especially a plurality of light sources, such as 2-1000, like 2-50 light sources. The term “radiationally coupled” especially means that the light source and the light concentrator are associated with each other so that at least part of the radiation emitted by the light source is received by the light concentrator (and at least partly converted into luminescence).

Hence, the luminescent concentrator receives at one or more radiation input faces radiation (pump radiation) from an upstream configured light concentrator or from upstream configured light sources. Further, the light concentrator comprises a luminescent material configured to convert at least part of a pump radiation received at one or more radiation input faces into luminescent material light, and the luminescent concentrator configured to couple at least part of the luminescent material light out at the radiation exit window as converter light. This converter light is especially used as component of the lighting device light.

The phrase “configured to provide luminescent material light at the radiation exit window” and similar phrases especially refers to embodiments wherein the luminescent material light is generated within the luminescent concentrator (i.e. within the light transmissive body), and part of the luminescent material light will reach the radiation exit window and escape from the luminescent concentrator. Hence, downstream of the radiation exit window the luminescent material light is provided. The converter light, downstream of the radiation exit window comprises at least the luminescent material light escaped via the radiation exit window from the light converter. Instead of the term “converter light” also the term “light concentrator light” may be used. Pump radiation can be applied to a single radiation input face or a plurality of radiation input faces.

In embodiments, the length (L) is selected from the range of 1-100 cm, such as especially 2-50 cm, like at least 3 cm, such as 5-50 cm, like at maximum 30 cm. This may thus apply to all luminescent concentrators. However, the range indicates that the different luminescent concentrators may have different lengths within this range.

In yet further embodiments, the elongated light transmissive body (of the luminescent concentrator) comprises an elongated ceramic body. For instance, luminescent ceramic garnets doped with Ce³⁺ (trivalent cerium) can be used to convert blue light into light with a longer wavelength, e.g. within the green to red wavelength region, such as in the range of about 500-750 nm. To obtain sufficient absorption and light output in desired directions, it is advantageous to use transparent rods (especially substantially shaped as beams). Such rod can be used as light concentrator, concentrating over their length light source light from light sources such as LEDs (light emitting diodes), converting this light source light into converter light and providing at an exit surface a substantial amount of converter light. Lighting devices based on light concentrators may e.g. be of interest for projector applications. For projectors, red, green and blue luminescent concentrators are of interest. Green luminescent rods, based on garnets, can be relatively efficient. Such concentrators are especially based on YAG:Ce (i.e. Y₃Al₅O₁₂:Ce³⁺) or LuAG (Lu₃Al₅O₁₂:Ce³⁺). ‘Red’ garnets can be made by doping a YAG-garnet with Gd (“YGdAG”). Blue luminescent concentrators can be based on YSO (Y₂SiO₅:Ce³⁺) or similar compounds (in general indicated as M₂SiO₅:Ce³⁺, wherein M comprises one or more of Y, Gd, Lu, especially one or more of Y and Lu) or BAM (BaMgAl₁₀O₁₇:Eu²⁺) or similar compounds, especially configured as single crystal(s). For isotropic crystalline materials, the concentrator may comprise a single crystal or ceramic. For anisotropic crystalline materials, the concentrator may especially comprise a single crystal. The term similar compounds especially refer to compounds having the same crystallographic structure but where one or more cations are at least partially replaced with another cation (e.g. Y replacing with Lu and/or Gd, or Ba replacing with Sr). Optionally, also anions may be at least partially replaced, or cation-anion combinations, such as replacing at least part of the Al—O with Si—N.

Hence, especially the elongated light transmissive body comprises a ceramic material configured to wavelength convert at least part of the (blue) light source light into converter light in e.g. one or more of the green, yellow and red, which converter light at least partly escapes from the radiation exit window. The ceramic material especially comprises an A₃B₅O₁₂:Ce³⁺ ceramic material (“ceramic garnet”), wherein A comprises yttrium (Y) and gadolinium (Gd), and wherein B comprises aluminum (Al). As further indicated below, A may also refer to other rare earth elements and B may include Al only, but may optionally also include gallium. The formula A₃B₅O₁₂:Ce³⁺ especially indicates the chemical formula, i.e. the stoichiometry of the different type of elements A, B and O (3:5:12). However, as known in the art the compounds indicated by such formula may optionally also include a small deviation from stoichiometry.

In yet a further aspect, the invention also provides such elongated light transmissive body per se, i.e. an elongated light transmissive body having a first face and a second face, these faces especially defining the length (L) of the elongated light transmissive body, the elongated light transmissive body comprising one or more radiation input faces and a radiation exit window, wherein the second face comprises the radiation exit window, wherein the elongated light transmissive body comprises a ceramic material configured to wavelength convert at least part of (blue) light source light into converter light, such as (at least) one or more of green, yellow, and red converter light (which at least partly escapes from the radiation exit window when the elongated light transmissive body is irradiated with blue light source light), wherein the ceramic material comprises an A₃B₅O₁₂:Ce³⁺ ceramic material as defined herein. Such light transmissive body can thus be used as light converter. Especially, such light transmissive body has the shape of a cuboid.

As indicated above, the ceramic material comprises a garnet material. Hence, the elongated body especially comprises a luminescent ceramic. The garnet material, especially the ceramic garnet material, is herein also indicated as “luminescent material”. The luminescent material comprises an A₃B₅O₁₂:Ce³¹⁺ (garnet material), wherein A is especially selected from the group consisting of Sc, Y, Tb, Gd, and Lu (especially at least Y and Gd), wherein B is especially selected from the group consisting of Al and Ga (especially at least Al). More especially, A (essentially) comprises yttrium (Y) and gadolinium (Gd), and B (essentially) comprises aluminum (Al). Such garnet is be doped with cerium (Ce), and optionally with other luminescent species such as praseodymium (Pr).

As indicated above, the element A may especially be selected from the group consisting of yttrium (Y) and gadolinium (Gd). Hence, A₃B₅O₁₂:Ce³¹⁺ especially refers to (Y₁₋ₓGdₓ)₃B₅O₁₂:Ce³⁺, wherein especially x is in the range of 0.1-0.5, even more especially in the range of 0.2-0.4, yet even more especially 0.2-0.35. Hence, A may comprise in the range of 50-90 atom % Y, even more especially at least 60-80 atom % Y, yet even more especially 65-80 atom % of A comprises Y. Further, A comprises thus especially at least 10 atom % Gd, such as in the range of 10-50 atom % Gd, like 20-40 atom %, yet even more especially 20-35 atom % Gd.

Especially, B comprises aluminum (Al), however, B may also partly comprise gallium (Ga) and/or scandium (Sc) and/or indium (In), especially up to about 20% of Al, more especially up to about 10% of Al may be replaced (i.e. the A ions essentially consist of 90 or more mole % of Al and 10 or less mole % of one or more of Ga, Sc and In); B may especially comprise up to about 10% gallium. Therefore, B may comprise at least 90 atom % Al. Hence, A₃B₅O₁₂:Ce³¹⁺ especially refers to (Y₁₋ₓGdₓ)₃Al₅O₁₂:Ce³⁺, wherein especially x is in the range of 0.1-0.5, even more especially in the range of 0.2-0.4.

In another variant, B (especially Al) and O may at least partly be replaced by Si and N. Optionally, up to about 20% of Al—O may be replaced by Si—N, such as up to 10%.

For the concentration of cerium, the indication n mole % Ce indicates that n % of A is replaced by cerium. Hence, A₃B₅O₁₂:Ce′ may also be defined as (A₁₋ₙCeₙ)₃B₅O₁₂, with n being in the range of 0.001-0.035, such as 0.0015-0.01. Therefore, a garnet essentially comprising Y and mole Ce may in fact refer to ((Y₁₋ₓGdₓ)₁₋ₙCeₙ)₃B₅O₁₂, with x and n as defined above.

Especially, the ceramic material is obtainable by a sintering process and/or a hot pressing process, optionally followed by an annealing in an (slightly) oxidizing atmosphere. The term “ceramic” especially relates to an inorganic material that is—amongst others—obtainable by heating a (poly crystalline) powder at a temperature of at least 500° C., especially at least 800° C., such as at least 1000° C., like at least 1400° C., under reduced pressure, atmospheric pressure or high pressure, such as in the range of 10⁻⁸ to 500 MPa, such as especially at least 0.5 MPa, like especially at least 1 MPa, like 1 to about 500 MPa, such as at least 5 MPa, or at least 10 MPa, especially under uniaxial or isostatic pressure, especially under isostatic pressure. A specific method to obtain a ceramic is hot isostatic pressing (HIP), whereas the HIP process may be a post-sinter HIP, capsule HIP or combined sinter-HIP process, like under the temperature and pressure conditions as indicate above. The ceramic obtainable by such method may be used as such, or may be further processed (like polishing). A ceramic especially has density that is at least 90% (or higher, see below), such as at least 95%, like in the range of 97-100%, of theoretical density (i.e. the density of a single crystal). A ceramic may still be polycrystalline, but with a reduced, or strongly reduced volume between grains (pressed particles or pressed agglomerate particles). The heating under elevated pressure, such as HIP, may e.g. be performed in an inert gas, such as comprising one or more of N₂ and argon (Ar). Especially, the heating under elevated pressures is preceded by a sintering process at a temperature selected from the range of 1400-1900° C., such as 1500-1800° C. Such sintering may be performed under reduced pressure, such as at a pressure of 10⁻² Pa or lower. Such sintering may already lead to a density of in the order of at least 95%, even more especially at least 99%, of theoretical density. After both the pre-sintering and the heating, especially under elevated pressure, such as HIP, the density of the light transmissive body can be close to the density of a single crystal. However, a difference is that grain boundaries are available in the light transmissive body, as the light transmissive body is polycrystalline. Such grain boundaries can e.g. be detected by optical microscopy or SEM. Hence, herein the light transmissive body especially refers to a sintered polycrystalline having a density substantially identical to a single crystal (of the same material). Such body may thus be highly transparent for visible light (except for the absorption by the light absorbing species such as especially Ce³⁺).

The luminescent concentrator may also be a crystal, such as a single crystal. Such crystals can be grown/drawn from the melt in a higher temperature process. The large crystal, typically referred to as boule, can be cut into pieces to form the light transmissive bodies. The polycrystalline garnets mentioned above are examples of materials that can alternatively also be grown in single crystalline form.

After obtaining the light transmissive body, the body may be polished. Before or after polishing an annealing process (in an oxidative atmosphere) may be executed, especially before polishing. In a further specific embodiment, the annealing process lasts for at least 2 hours, such as at least 2 hours at at least 1200° C. Further, especially the oxidizing atmosphere comprises for example O₂.

Instead of cerium doped garnets, or in addition to such garnets, also other luminescent materials may be applied, e.g. embedded in organic or inorganic light transmissive matrixes, as luminescent concentrator. For instance quantum dots and/or organic dyes may be applied and may be embedded in transmissive matrices like e.g. polymers, like PMMA, or polysiloxanes, etc. etc.

Quantum dots are small crystals of semiconducting material generally having a width or diameter of only a few nanometers. When excited by incident light, a quantum dot emits light of a color determined by the size and material of the crystal. Light of a particular color can therefore be produced by adapting the size of the dots. Most known quantum dots with emission in the visible range are based on cadmium selenide (CdSe) with a shell such as cadmium sulfide (CdS) and zinc sulfide (ZnS). Cadmium free quantum dots such as indium phosphode (InP), and copper indium sulfide (CuInS₂) and/or silver indium sulfide (AgInS₂) can also be used. Quantum dots show very narrow emission band and thus they show saturated colors. Furthermore the emission color can easily be tuned by adapting the size of the quantum dots. Any type of quantum dot known in the art may be used in the present invention. However, it may be preferred for reasons of environmental safety and concern to use cadmium-free quantum dots or at least quantum dots having a very low cadmium content.

Instead of quantum dots or in addition to quantum dots, also other quantum confinement structures may be used. The term “quantum confinement structures” should, in the context of the present application, be understood as e.g. quantum wells, quantum dots, quantum rods, or nano-wires.

Organic phosphors can be used as well. Examples of suitable organic phosphor materials are organic luminescent materials based on perylene derivatives, for example compounds sold under the name Lumogen® by BASF. Examples of suitable compounds include, but are not limited to, Lumogen® Red F305, Lumogen® Orange F240, Lumogen® Yellow F083, and Lumogen® F170.

Several color conversion schemes may be possible. Especially, however, the Stokes shift is relatively small. Especially, the Stokes shift, defined as the difference (in wavelength) between positions of the band maxima of the light source used for pumping and the light which is emitted, is not larger than 100 nm; especially however, the Stokes shift is at least about 10 nm, such as at least about 20 nm. This may especially apply to the light source light to first luminescent material light conversion, but also apply to the second pump radiation to second luminescent material light conversion, etc.

In embodiments, the plurality of light sources are configured to provide UV radiation as first pump radiation, and the luminescent concentrators are configured to provide one or more of blue and green first converter light. In yet other embodiments, the plurality of light sources are configured to provide blue radiation as first pump radiation, and the luminescent concentrators are configured to provide one or more of green and yellow first converter light. Note, as also indicated below, such embodiments may also be combined.

The lighting device may further comprise a cooling element in thermal contact with the luminescent concentrator. The cooling element can be a heatsink or an actively cooled element, such as a Peltier element. Further, the cooling element can be in thermal contact with the light transmissive body via other means, including heat transfer via air or with an intermediate element that can transfer heat, such as a thermal grease. Especially, however, the cooling element is in physical contact with the light transmissive body. The term “cooling element” may also refer to a plurality of (different) cooling elements.

Hence, the lighting device may include a heatsink configured to facilitate cooling of the solid state light source and/or luminescent concentrator. The heatsink may comprise or consist of copper, aluminum, silver, gold, silicon carbide, aluminum nitride, boron nitride, aluminum silicon carbide, beryllium oxide, silicon-silicon carbide, aluminum silicon carbide, copper tungsten alloys, copper molybdenum carbides, carbon, diamond, graphite, and combinations of two or more thereof. Hence, the term “heatsink” may also refer to a plurality of (different) heatsink. The lighting device may further include one or more cooling elements configured to cool the light transmissive body. With the present invention, cooling elements or heatsinks may be used to cool the light transmissive body and the same or different cooling elements or heatsinks may be used to cool the light sources. The cooling elements or heatsinks may also provide interfaces to further cooling means or allow cooling transport to dissipate the heat to the ambient. For instance, the cooling elements or heatsinks may be connected to heat pipes or a water cooling systems that are connect to more remotely placed heatsinks or may be directly cooled by air flows such as generated by fans. Both passive and active cooling may be applied.

In particular embodiments, the elongated luminescent concentrator is clamped between 2 metal plates or clamped within a housing consisting of a highly thermal conductive material such way that a sufficient air gap between the elongated luminescent concentrator remains present to provide TIR (tatal internal reflection) of the light trapped within the elongated luminescent concentrator while a sufficient amount of heat may traverse from the elongated luminescent concentrator through the air gap towards the highly thermal conductive housing. The thickness of the air gap is higher than the wavelength of the light, e.g. higher than 0.1 μm, e.g. higher 0.5 μm. The elongated luminescent concentrator is secured in the housing by providing small particles between the elongated luminescent concentrator and the houses, such as small spheres of rods having a diameter higher than 0.1 μm, e.g. higher 0.5 μm, preferably smaller than 1 μm. Alternatively, the elongated luminescent concentrator may be secured in the housing by providing some surface roughness on the surfaces of the highly thermal conductive housing touching the elongated luminescent concentrator, the surface roughness varying over a depth higher than 0.1 μm, e.g. higher 0.5 μm, preferably smaller than 1 μm.

The density of such spheres, rods or touch points of a rough surface of the highly thermal conductive housing is relatively very small, such most of the surface area of the elongated light transmissive body remains untouched securing a high level of TIR reflections within of the light trapped within the elongated light transmissive body.

The lighting device may comprise a plurality of luminescent concentrators, such as in the range of 2-50, like 2-20 light concentrators (which may e.g. be stacked).

The lighting device may be part of or may be applied in e.g. office lighting systems, household application systems, shop lighting systems, home lighting systems, accent lighting systems, spot lighting systems, theater lighting systems, architectural lighting, fiber-optics application systems, projection systems, self-lit display systems, pixelated display systems, segmented display systems, warning sign systems, medical lighting application systems, indicator sign systems, decorative lighting systems, portable systems, automotive applications, green house lighting systems, horticulture lighting, or LCD backlighting, etc.

In yet a further aspect, the invention provides a projector comprising the lighting device as defined herein. As indicated above, of course the light projector may also include a plurality of such lighting devices.

In yet a further aspect, the invention also provides a lighting system configured to provide lighting system light, the lighting system comprising one or more lighting devices as defined herein. Here, the term “lighting system” may also be used for a (digital) projector. Further, the lighting device may be used for e.g. stage lighting (see further also below), or architectural lighting. Therefore, in embodiments the invention also provides a lighting system as defined herein, wherein the lighting system comprises a digital projector, a stage lighting system or an architectural lighting system. The lighting system may comprise one or more lighting devices as defined herein and optionally one or more second lighting devices configured to provide second lighting device light, wherein the lighting system light comprises (a) one or more of (i) the converter light as defined herein, and optionally (b) second lighting device light. Hence, the invention also provides a lighting system configured to provide visible light, wherein the lighting system comprises at least one lighting device as defined herein. For instance, such lighting system may also comprise one or more (additional) optical elements, like one or more of optical filters, collimators, reflectors, wavelength converters, lens elements, etc. The lighting system may be, for example, a lighting system for use in an automotive application, like a headlight. Hence, the invention also provides an automotive lighting system configured to provide visible light, wherein the automotive lighting system comprises at least one lighting device as defined herein and/or a digital projector system comprising at least one lighting device as defined herein. Especially, the lighting device may be configured (in such applications) to provide red light. The automotive lighting system or digital projector system may also comprise a plurality of the lighting devices as described herein.

Alternatively, the lighting device may be designed to provide high intensity UV radiation, e.g. for 3D printing technologies or UV sterilization applications. Alternatively, the lighting device may be designed to provide a high intensity IR light beam, e.g., to project IR images for (military) training purposes.

The terms “upstream” and “downstream” relate to an arrangement of items or features relative to the propagation of the light from a light generating means (here the especially the light source(s)), wherein relative to a first position within a beam of light from the light generating means, a second position in the beam of light closer to the light generating means is “upstream”, and a third position within the beam of light further away from the light generating means is “downstream”.

In an aspect, the invention also provides a lighting device comprising a beam shaping assembly as defined herein, such as optically coupled to a light source and/or a light transmissive body.

Yet further, the invention also provides a spot lighting system comprising such lighting device (i.e. a lighting device comprising a beam shaping assembly as defined herein, such as optically coupled to a light source and/or a light transmissive body).

Yet further, the invention also provides an image projection system comprising such lighting device (i.e. a lighting device comprising a beam shaping assembly as defined herein, such as optically coupled to a light source and/or a light transmissive body).

Herein, the term “visible light” especially relates to light having a wavelength selected from the range of 380-780 nm. The transmission can be determined by providing light at a specific wavelength with a first intensity to the light transmissive body under perpendicular radiation and relating the intensity of the light at that wavelength measured after transmission through the material, to the first intensity of the light provided at that specific wavelength to the material (see also E-208 and E-406 of the CRC Handbook of Chemistry and Physics, 69th edition, 1088-1989).

The term white light herein, is known to the person skilled in the art. It especially relates to light having a correlated color temperature (CCT) between about 2000 and 20000 K, especially 2700-20000 K, for general lighting especially in the range of about 2700 K and 6500 K, and for backlighting purposes especially in the range of about 7000 K and 20000 K, and especially within about 15 SDCM (standard deviation of color matching) from the BBL (black body locus), especially within about 10 SDCM from the BBL, even more especially within about 5 SDCM from the BBL, such as within about 3 SDCM from the BBL.

The terms “violet light” or “violet emission” especially relates to light having a wavelength in the range of about 380-440 nm. The terms “blue light” or “blue emission” especially relates to light having a wavelength in the range of about 440-490 nm (including some violet and cyan hues). The terms “green light” or “green emission” especially relate to light having a wavelength in the range of about 490-560 nm. The terms “yellow light” or “yellow emission” especially relate to light having a wavelength in the range of about 560-570 nm. The terms “orange light” or “orange emission” especially relate to light having a wavelength in the range of about 570-600. The terms “red light” or “red emission” especially relate to light having a wavelength in the range of about 600-780 nm. The term “pink light” or “pink emission” refers to light having a blue and a red component. The terms “visible”, “visible light” or “visible emission” refer to light having a wavelength in the range of 380-780 nm. The term UV light may be UV-A (315-400 nm); UV-B (280-315 nm) or UV-C (200-280 nm). The term IR light may be light in the range above 780 nm. The term “white light” may in embodiments refer to light consisting of particular spectral compositions of wavelengths in the range between 380-780 nm, perceived nearby Plancks black body radiators having temperatures of about 1000 K and above.

The terms “coupling in” and similar terms and “coupling out” and similar terms indicate that light changes from medium (external from the light transmissive body into the light transmissive body, and vice versa, respectively). In general, the light exit window will be a face (or a part of a face), configured (substantially) perpendicular to one or more other faces of the waveguide. In general, the light transmissive body will include one or more body axes (such as a length axis, a width axis or a height axis), with the exit window being configured (substantially) perpendicular to such axis. Hence, in general, the light input face(s) will be configured (substantially) perpendicular to the light exit window. Thus, the radiation exit window is especially configured perpendicular to the one or more radiation input faces. Therefore, especially the face comprising the light exit window does not comprise a light input face.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1e schematically depict some aspects of the invention;

FIGS. 2a-2b schematically depict some options not chosen herein;

FIG. 3 shows the spectral distribution of such options of FIGS. 2a-2b;

FIG. 4 schematically depicts an embodiment of the lighting device;

FIG. 5 schematically depicts another embodiment of the lighting device; and

FIG. 6 schematically depicts an embodiment of the third light source.

The schematic drawings are not necessarily to scale.

### DETAILED DESCRIPTION OF THE EMBODIMENTS

A light emitting device according to the invention may be used in applications including but not being limited to a lamp, a light module, a luminaire, a spot light, a flash light, a projector, a (digital) projection device, automotive lighting such as e.g. a headlight or a taillight of a motor vehicle, arena lighting, theater lighting and architectural lighting.

Light sources which are part of the embodiments according to the invention as set forth below, may be adapted for, in operation, emitting light with a first spectral distribution. This light is subsequently coupled into a light guide or waveguide; here the light transmissive body. The light guide or waveguide may convert the light of the first spectral distribution to another spectral distribution and guides the light to an exit surface.

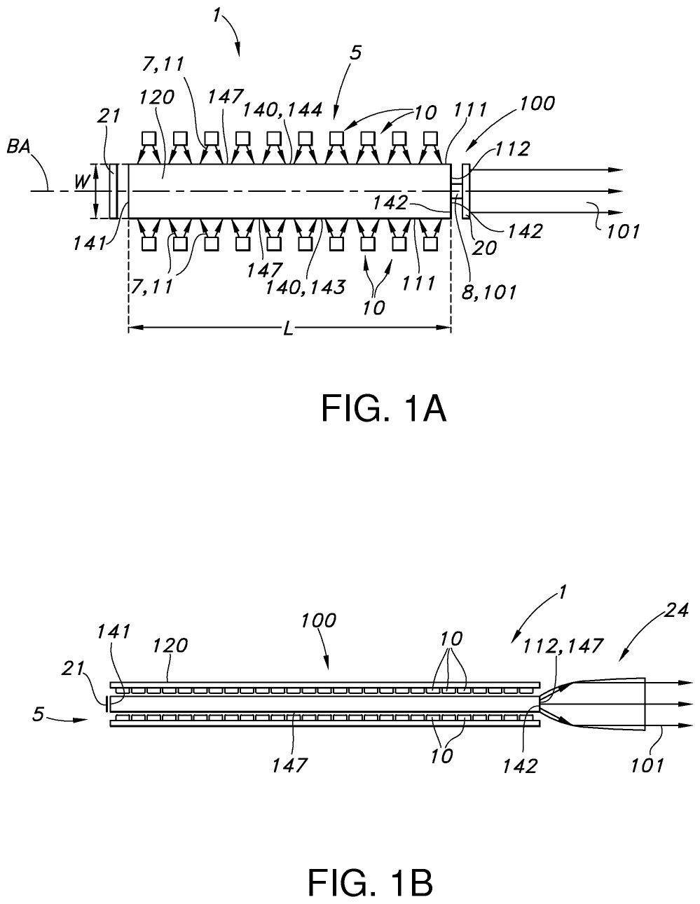

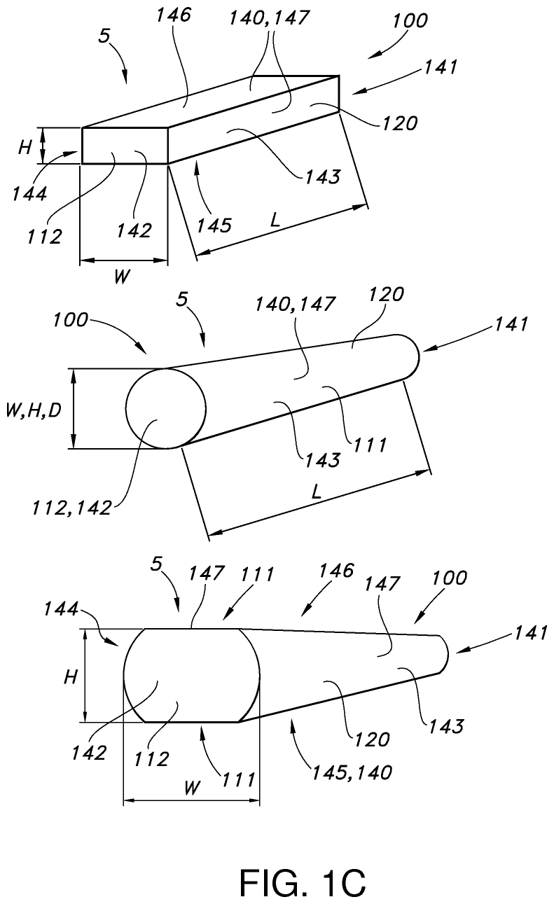

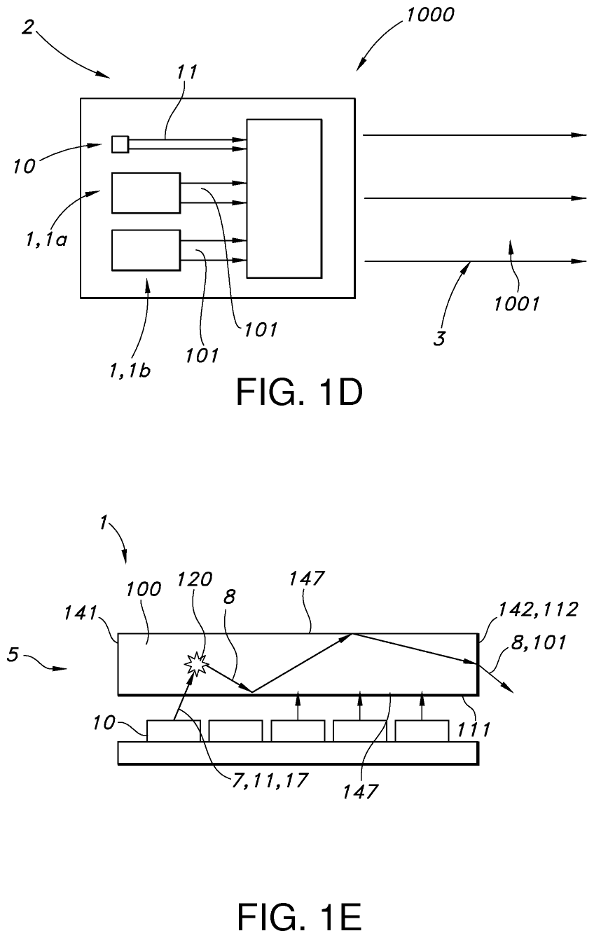

An embodiment of the lighting device as defined herein is schematically depicted in FIG. 1a. FIG. 1a schematically depicts a lighting device 1 comprising a plurality of solid state light sources 10 and a luminescent concentrator 5 comprising an elongated light transmissive body 100 having a first face 141 and a second face 142 defining a length L of the elongated light transmissive body 100. The elongated light transmissive body 100 comprising one or more radiation input faces 111, here by way of example two oppositely arranged faces, indicated with references 143 and 144 (which define e.g. the width W), which are herein also indicated as edge faces or edge sides 147. Further the light transmissive body 100 comprises a radiation exit window 112, wherein the second face 142 comprises the radiation exit window 112. The entire second face 142 may be used or configured as radiation exit window. The plurality of solid state light sources 10 are configured to provide (blue) light source light 11 to the one or more radiation input faces 111. As indicated above, they especially are configured to provide to at least one of the radiation input faces 111 a blue power Wₒₚₜ of in average at least 0.067 Watt/mm². Reference BA indicates a body axis, which will in cuboid embodiments be substantially parallel to the edge sides 147. Reference 140 refers to side faces or edge faces in general.

The elongated light transmissive body 100 may comprise a ceramic material 120 configured to wavelength convert at least part of the (blue) light source light 11 into converter light 101, such as at least one or more of green and red converter light 101. As indicated above the ceramic material 120 comprises an A₃B₅O₁₂:Ce³⁺ ceramic material, wherein A comprises e.g. one or more of yttrium (Y), gadolinium (Gd) and lutetium (Lu), and wherein B comprises e.g. aluminum (Al). References 20 and 21 indicate an optical filter and a reflector, respectively. The former may reduce e.g. non-green light when green light is desired or may reduce non-red light when red light is desired. The latter may be used to reflect light back into the light transmissive body or waveguide, thereby improving the efficiency. Note that more reflectors than the schematically depicted reflector may be used. Note that the light transmissive body may also essentially consist of a single crystal, which may in embodiments also be A₃B₅O₁₂:Ce³⁺.

The light sources may in principle be any type of light source, but is in an embodiment a solid state light source such as a Light Emitting Diode (LED), a Laser Diode or Organic Light Emitting Diode (OLED), a plurality of LEDs or Laser Diodes or OLEDs or an array of LEDs or Laser Diodes or OLEDs, or a combination of any of these. The LED may in principle be an LED of any color, or a combination of these, but is in an embodiment a blue light source producing light source light in the UV and/or blue color-range which is defined as a wavelength range of between 380 nm and 490 nm. In another embodiment, the light source is an UV or violet light source, i.e. emitting in a wavelength range of below 420 nm. In case of a plurality or an array of LEDs or Laser Diodes or OLEDs, the LEDs or Laser Diodes or OLEDs may in principle be LEDs or Laser Diodes or OLEDs of two or more different colors, such as, but not limited to, UV, blue, green, yellow or red.

The light sources 10 are configured to provide light source light 11, which is used as pump radiation 7. The luminescent material 120 converts the light source light into luminescent material light 8 (see also FIG. 1e). Light escaping at the light exit window is indicated as converter light 101, and will include luminescent material light 8. Note that due to reabsorption part of the luminescent material light 8 within the luminescent concentrator 5 may be reabsorbed. Hence, the spectral distribution may be redshifted relative e.g. a low doped system and/or a powder of the same material. The lighting device 1 may be used as luminescent concentrator to pump another luminescent concentrator.

FIGS. 1a-1b schematically depict similar embodiments of the lighting device. Further, the lighting device may include further optical elements, either separate from the waveguide and/or integrated in the waveguide, like e.g. a light concentrating element, such as a compound parabolic light concentrating element (CPC). The lighting devices 1 in FIG. 1b further comprise a collimator 24, such as a CPC.

As shown in FIGS. 1a-1b and other Figures, the light guide has at least two ends, and extends in an axial direction between a first base surface (also indicated as first face 141) at one of the ends of the light guide and a second base surface (also indicated as second face 142) at another end of the light guide.

FIG. 1c schematically depicts some embodiments of possible ceramic bodies or crystals as waveguides or luminescent concentrators. The faces are indicated with references 141-146. The first variant, a plate-like or beam-like light transmissive body has the faces 141-146. Light sources, which are not shown, may be arranged at one or more of the faces 143-146 (general indication of the edge faces is reference 147). The second variant is a tubular rod, with first and second faces 141 and 142, and a circumferential face 143. Light sources, not shown, may be arranged at one or more positions around the light transmissive body. Such light transmissive body will have a (substantially) circular or round cross-section. The third variant is substantially a combination of the two former variants, with two curved and two flat side faces.

In the context of the present application, a lateral surface of the light guide should be understood as the outer surface or face of the light guide along the extension thereof. For example, in case the light guide would be in form of a cylinder, with the first base surface at one of the ends of the light guide being constituted by the bottom surface of the cylinder and the second base surface at the other end of the light guide being constituted by the top surface of the cylinder, the lateral surface is the side surface of the cylinder. Herein, a lateral surface is also indicated with the term edge faces or side 140.

The variants shown in FIG. 1c are not limitative. More shapes are possible; i.e. for instance referred to WO2006/054203, which is incorporated herein by reference. The ceramic bodies or crystals, which are used as light guides, generally may be rod shaped or bar shaped light guides comprising a height H, a width W, and a length L extending in mutually perpendicular directions and are in embodiments transparent, or transparent and luminescent. The light is guided generally in the length L direction. The height H is in embodiments <10 mm, in other embodiments <5 mm, in yet other embodiments <2 mm. The width W is in embodiments <10 mm, in other embodiments <5 mm, in yet embodiments <2 mm. The length L is in embodiments larger than the width W and the height H, in other embodiments at least 2 times the width W or 2 times the height H, in yet other embodiments at least 3 times the width W or 3 times the height H. Hence, the aspect ratio (of length/width) is especially larger than 1, such as equal to or larger than 2, such as at least 5, like even more especially in the range of 10-300, such as 10-100, like 10-60, like 10-20. Unless indicated otherwise, the term “aspect ratio” refers to the ratio length/width. FIG. 1c schematically depicts an embodiment with four long side faces, of which e.g. two or four may be irradiated with light source light.

The aspect ratio of the height H: width W is typically 1:1 (for e.g. general light source applications) or 1:2, 1:3 or 1:4 (for e.g. special light source applications such as headlamps) or 4:3, 16:10, 16:9 or 256:135 (for e.g. display applications). The light guides generally comprise a light input surface and a light exit surface which are not arranged in parallel planes, and in embodiments the light input surface is perpendicular to the light exit surface. In order to achieve a high brightness, concentrated, light output, the area of light exit surface may be smaller than the area of the light input surface. The light exit surface can have any shape, but is in an embodiment shaped as a square, rectangle, round, oval, triangle, pentagon, or hexagon.

Note that in all embodiments schematically depicted herein, the radiation exit window is especially configured perpendicular to the radiation input face(s). Hence, in embodiments the radiation exit window and radiation input face(s) are configured perpendicular. In yet other embodiments, the radiation exit window may be configured relative to one or more radiation input faces with an angle smaller or larger than 90°.

Note that, in particular for embodiments using a laser light source to provide light source light, the radiation exit window might be configured opposite to the radiation input face(s), while the mirror 21 may consist of a mirror having a hole to allow the laser light to pass the mirror while converted light has a high probability to reflect at mirror 21. Alternatively or additionally, a mirror may comprise a dichroic mirror.

FIG. 1d very schematically depicts a projector or projector device 2 comprising the lighting device 1 as defined herein. By way of example, here the projector 2 comprises at least two lighting devices 1, wherein a first lighting device (1a) is configured to provide e.g. green light 101 and wherein a second lighting device (1b) is configured to provide e.g. red light 101. Light source 10 is e.g. configured to provide blue light. These light sources may be used to provide the projection (light) 3. Note that the additional light source 10, configured to provide light source light 11, is not necessarily the same light source as used for pumping the luminescent concentrator(s). Further, here the term “light source” may also refer to a plurality of different light sources. The projector device 2 is an example of a lighting system 1000, which lighting system is especially configured to provide lighting system light 1001, which will especially include lighting device light 101.

High brightness light sources are interesting for various applications including spots, stage-lighting, headlamps and digital light projection.

For this purpose, it is possible to make use of so-called luminescent concentrators where shorter wavelength light is converted to longer wavelengths in a highly transparent luminescent material. A rod of such a transparent luminescent material can be used and then it is illuminated by LEDs to produce longer wavelengths within the rod. Converted light which will stay in the luminescent material such as a doped garnet in the waveguide mode and can then be extracted from one of the surfaces leading to an intensity gain (FIG. 1e).

High-brightness LED-based light source for beamer applications appear to be of relevance. For instance, the high brightness may be achieved by pumping a luminescent concentrator rod by a discrete set of external blue LEDs, whereupon the phosphor that is contained in the luminescent rod subsequently converts the blue photons into green or red photons. Due to the high refractive index of the luminescent rod host material (typically 1.8) the converted green or red photons are almost completely trapped inside the rod due to total internal reflection. At the exit facet of the rod the photons are extracted from the rod by means of some extraction optics, e.g. a compound parabolic concentrator (CPC), or a micro-refractive structure (micro-spheres or pyramidal structures). As a result the high luminescent power that is generated inside the rod can be extracted at a relatively small exit facet, giving rise to a high source brightness, enabling (1) smaller optical projection architectures and (2) lower cost of the various components because these can be made smaller (in particular the, relatively expensive, projection display panel).

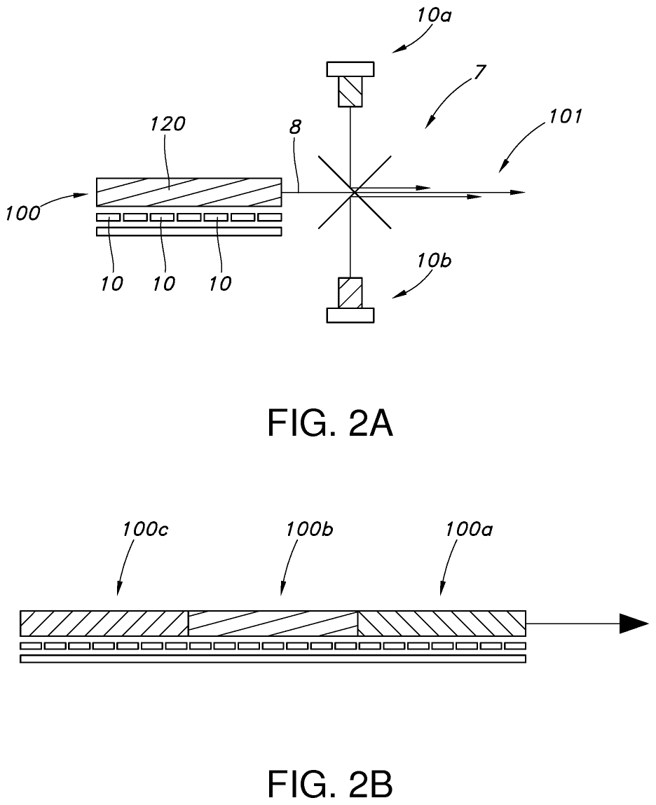

The light concentrator with luminescent material (“luminescent concentrator”) concept can generate extremely high flux densities. By combining a green/yellow luminescent concentrator module with a high brightness blue and red LED in combination with a dichroic cross or mirrors, white light can be generated (see FIG. 2a). In this Figure, schematically a luminescent concentrator or light transmissive body 100 with luminescent material 120 is depicted, with one or more light sources 10, here a plurality of light sources 10, which together provide luminescent material light 8. References 10a and 10b schematically depict a blue and a red LED; reference 7 indicates a dichroic cross. Reference 101 indicates the resulting lighting device light.

The green/yellow phosphor (example of commonly used luminescent material 120) has an emission having a tail in the red part of the spectrum, overlapping with the red emission of the direct red LED. So a part of the phosphor emission is blocked by the dichroic mirror. This is also true if a phosphor converted green LED is used instead of a green HLD (high lumen density) module.

In principle it is also possible to make a high brightness spot based on the luminescent concentrator principle only, by using a blue rod (pumped with UV LEDS), indicated with reference 100a, in combination with a yellow/green rod (low CRI, high CCT), indicated with reference 100b (lower example). By adding a third red rod, indicated with reference 100c (see upper example), low CCT, higher CRI can be generated (FIG. 2b). The material currently in development for red (YGdAG:Ce) is emitting at too short wavelength to obtain high CRI warm/neutral white light (required for high-end spot applications).

Using a combination of a red, a green and a blue luminescent concentrators (see FIG. 2b) it is not possible to generate white light with a high CRI and low CCT, since no transparent red material is available that emits at the correct wavelength (˜620 nm for narrow red and ˜640 nm for a broader emission).

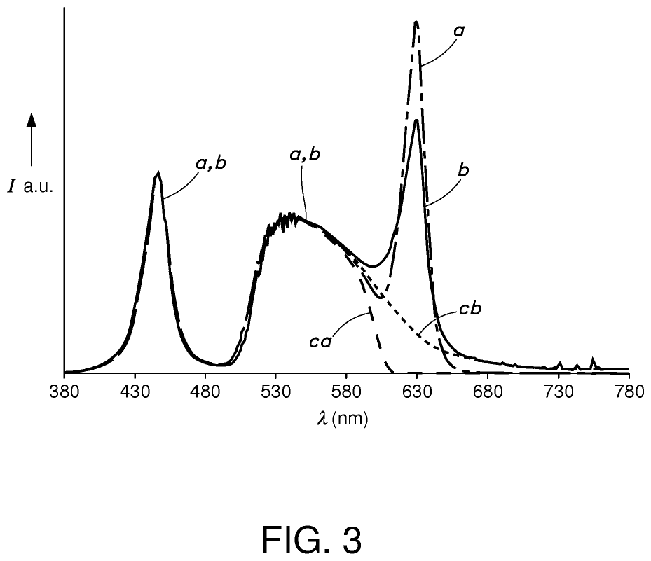

The options using a direct red LED, in combination with a phosphor converted green LED and a blue LED, in combination with dichroic mirrors suffers from the disadvantage that part of the light is lost due to the overlap in the emission spectra of green and red (FIG. 3). FIG. 3 shows a 4000K spectrum generated using a blue and red LED in combination with a phosphor converted green LED. Spectrum a shows the result of such configuration with a dichroic; spectrum b shows the result of such configuration without dichroic. The dashed curves cb and ca indicate the contribution of the green phosphor to the spectra, respectively. As a consequence the amount of red light required increases significantly. Moreover, a dip in the spectrum will occur at the position of the dichroic mirrors, which could lead to a degradation of the CRI. The example in FIG. 3 shows that 0.70 W of red light is needed to generate 1 kLm of white light in the case that all green light has to pass through the dichroic, whereas only 0.47 W of red light is needed per kLm in the case without dichroic.

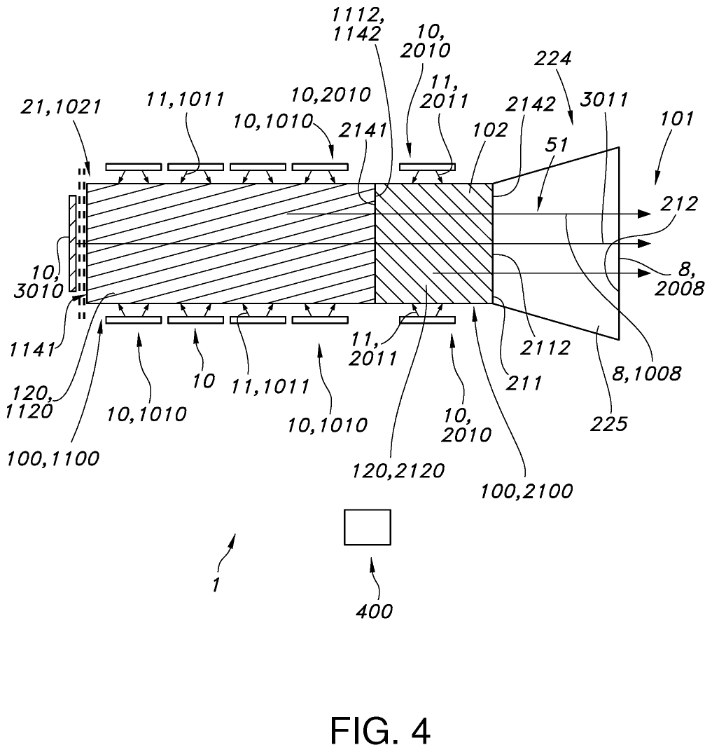

Hence, herein it is proposed to use a blue luminescent concentrator pumped with UV LEDs, a green/yellow rod pumped with blue LEDs in combination with a (direct) red LED. The red LED is positioned at the surface opposite to the nose of the rod (FIG. 4). With the correct choice of the yellow/green rod, the blue luminescent concentrator and a red-amber LED, light with high CRI/R9 at low CCT's can be made. Using this arrangement only ˜50% of the green light has to pass through the dichroic.

If desired, the color point of the spot can be tuned over a wide range by adjusting the current through the different LED strings. High intensity systems with over 3000 Lm can be generated. Larger concentrator cross-sections allow larger red LEDs. The amount of green and blue can be boosted by increasing the concentrator length and/or cross-section (e.g. diameter when using a circular rod).

FIG. 4 schematically depicts an embodiment of a lighting device 1 comprising light sources 10 configured to provide light source light 11 and light transmissive bodies 100 comprising a luminescent material 120 configured to convert at least part of the light source light 11 into luminescent material light 8.

More specifically, the device 1 comprises a first light source 1010, configured to provide first light source light 1011, which may e.g. be in the blue. Further, the device comprises a first light transmissive body 1100, such as a cerium comprising garnet. The first light source(s) 1011 and first light transmissive body 1100 are especially configured to provide first luminescent material light 1008, which may e.g. be one or more of green and yellow.

The first (elongated) light transmissive body 1100 may have a first face 1141 and a second face 1142 defining a length of the first (elongated) light transmissive body 1100. The first face may be configured to allow entrance of the third light source light 3011. The second face 1142 may comprise a radiation exit window 1112 from which at least part of the third light source light 3011 and/or first luminescent material light 1008 may escape.

The device 1 further comprises a second light source 2010, configured to provide second light source light 2011, especially UV and/or violet, especially UV. Further, the device 1 comprises a second light transmissive body 2100, which may e.g. a BAM crystal. The second light source(s) 2010 and the second light transmissive body are especially configured to provide second luminescent material light 2008 spectrally different from first luminescent material light 1008, such as especially blue light. Hence, the light transmissive bodies 100 (of the luminescent concentrators) comprise luminescent materials, which will in general differ. This is indicated with first luminescent material 1120, comprised by the first light transmissive body 1010, and with second luminescent material 2120, comprised by the second light transmissive body 2010.

The second (elongated) light transmissive body 2100 may have a first face 2141 and a second face 2142 defining a length of the second (elongated) light transmissive body 2100. The first face may be configured to allow entrance of the third light source light 3011 and the first luminescent material light 1008. The second face 2142 may comprise a radiation exit window 2112 from which at least part of the third light source light 3011 and/or first luminescent material light 1008 and/or second luminescent material light 2008 may escape.

Note that in specific embodiments, the first light transmissive body and second light transmissive body may be a single light transmissive body; in such embodiments, the second face of the first light transmissive body and the first face of the second light transmissive body will be absent (see also below).

The first light transmissive body 1100 comprises a first luminescent material 1120 and the second light transmissive body comprises a second luminescent material 2120, with the former providing first luminescent material light 1008 upon excitation by the light 1011 of the first light sources and the latter providing second luminescent material light 2008 upon excitation by the light 2011 of the second light sources 2010. The first luminescent material 1120 and second luminescent material 2120 may comprise the same luminescent materials but with different (activator) concentrations and/or may comprise different luminescent materials. In this way, the first luminescent material light 1008 and second luminescent material light 2008 spectrally differ.

The device 1 also further comprises a third light source 3010 which is configured to provide third light source light 3011 spectrally different from the first luminescent material light 1008 and the second luminescent material light 2008. The third light source light 3011 is especially red light.

As shown in FIG. 4, the third light source 3010 is configured upstream of the first light transmissive body 1100. The first light transmissive body 1100 is transmissive for at least part of the third light source light 3011. Further, as can be seen from FIG. 4, the first light transmissive body 1100 may be configured upstream of the second light transmissive body 2100. The second light transmissive body 2100 is transmissive for at least part of the third light source light 3011 that is transmitted through the first light transmissive body 1100 and transmissive for at least part of the first luminescent material light 1008.

The second light transmissive body 2100 comprising a second radiation exit window 2112 configured to provide outcoupled light 51. Further, the lighting device 1 is configured to provide lighting device light 101 comprising the outcoupled light 51. The lighting device may at least be able to provide white light. Hence, in a first mode of the lighting device 1 the lighting device light comprises white light comprising at least part of the third light source light 3011, at least part of the first luminescent material light 1008, and at least part of the second luminescent material light 2008. Would a control system 400 be applied, the spectral distribution of the lighting device light 101 may be controllable. The control system may be configured to control the intensity of the light source light 11 of the light sources, or subsets of light sources (such as all first light sources 1010, all second light sources 2010, and all third light sources 3010, respectively).

The lighting device 1 may further comprise a beam shaping optical element 224 optically coupled with the second radiation exit window 2112, configured to beam shape the outcoupled light 51. The beam shaping element may be a light transmissive body. The beam shaping optical element 224 comprises a radiation entrance window 211 configured to receive at least part of the converter light and a radiation exit window 212. The distance between the radiation entrance window 211 and the radiation exit window 212 defines a length of a light transmissive body 225 of the beam shaping optical element 224. Especially, the beam shaping optical element 224 comprises a light transmissive body where the radiation exit window 212 has a larger cross section than the radiation entrance window. Hence, the beam shaping optical element may tapers from the radiation exit window 212 to the radiation entrance window 211.

In embodiments, the first light transmissive body 1100 and the second light transmissive body 2100 are comprised by a single light transmissive body. In other embodiments, as schematically depicted here, the first light transmissive body 1100 and the second light transmissive body 2100 are different light transmissive bodies.

Further, the beam shaping optical element 224 and the directly upstream arranged light transmissive body 100 may be configured as single body. The luminescent converter part may comprise the luminescent material 120, and the beam shaping optical element part may not comprise such luminescent material. In such embodiments, the radiation exit window 2112 may essentially coincide with the radiation exit window 212 of the beam shaping optical element 225.

Further, in specific embodiments, the first light source 1010 may be configured to provide blue first light source light 1011, and the first light source 1010 and first light transmissive body 1100 are configured to provide first luminescent material light 1008 having an intensity in one or more of the green and yellow spectral parts of the visible spectrum. The second light source 2010 may be configured to provide second light source light 2011 having an intensity in one or more of the UV and blue spectral parts of the visible spectrum, and wherein the second light source 2010 and the second light transmissive body 2100 are configured to provide second luminescent material light 2008 having an intensity in the blue spectral part of the visible spectrum. Yet further, the third light source 3010 is configured to provide third light source light having an intensity in the red spectral part of the visible spectrum. In this way, white light may be generated when desired.

The lighting device 1 may further especially comprise a first optical filter element 1021 configured downstream of the third light source 3010 and upstream of the first light transmissive body 1100. The first optical filter element 1021 may especially be configured to transmit at least part of the third light source light 3011 and to reflect at least part of one or more of first light source light 1011, first luminescent material light 1008, second light source light 2011, and second luminescent material light 2008. The first optical filter element 1021 may e.g. comprises a dichroic filter.

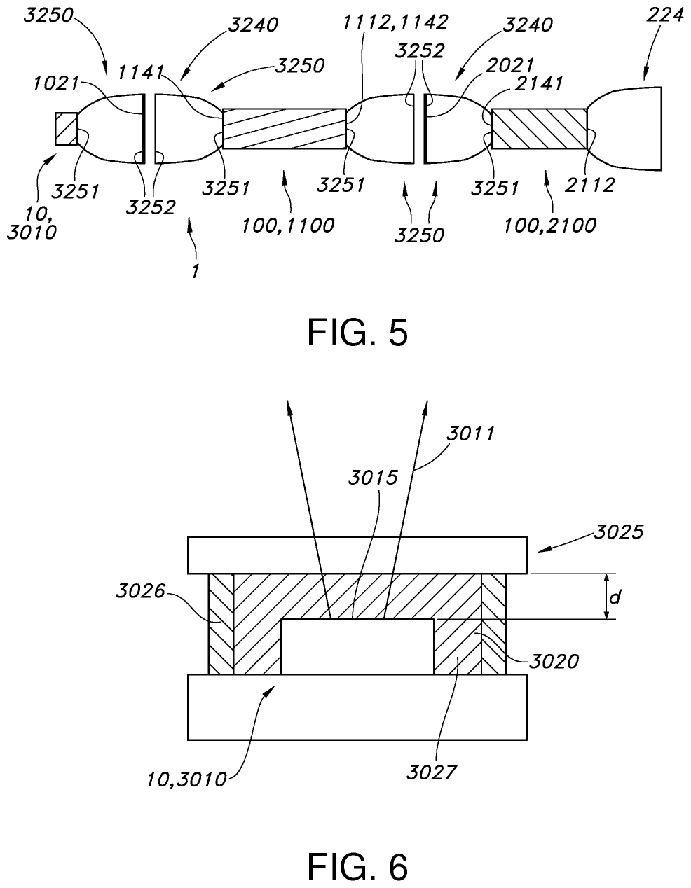

FIG. 5 schematically depicts an embodiment of the device with two beam shaping assemblies 3240, of which one or both (or none; see FIG. 4) may be available. The beam shaping assembly 3240 comprises two light transmissive beam shaping elements 3250, each beam shaping element 3250 having a first end window 3251 and a second end window 3252, larger than the first end window 3251, with the beam shaping element 3250 tapering from the second end window 3252 to the first end window 3251. The two light transmissive beam shaping elements 3250 are configured with the second end windows 3252 facing each other. In an embodiment, the first optical filter element 1021 is configured between the two light transmissive beam shaping elements 3250. The optical filter element 1021 may be comprised by one of the beam shaping elements 3250 or may be configured in between. In specific embodiments, the two light transmissive beam shaping elements 3250 are not physically coupled. Hence, this embodiment of the beam shaping assembly may also be applied in FIG. 4 between the third light source 3010 and the first light transmissive body 1100.

FIG. 5 also schematically depicts an optional second optical filter element 2021. The second optical filter element 2021 is configured downstream of the first light transmissive body 1100 and upstream of the second light transmissive body 2100. The second optical filter element 2021 is configured to transmit at least part of the third light source light 3011 and at least part of the first luminescent material light 1008 and to reflect at least part of one or more of the second light source light 2011 and the second luminescent material light 2008 (see also FIG. 4). Especially, the second optical filter element 2021 comprises a dichroic filter.

Further, FIG. 5 schematically depicts an option beam shaping assembly 3240 between the first light transmissive body 1100 and the second light transmissive body 2100. Also this beam shaping assembly 3240 comprises two light transmissive beam shaping elements 3250, each beam shaping element 3250 having a first end window 3251 and a second end window 3252, larger than the first end window 3251, with the beam shaping element 3250 tapering from the second end window 3252 to the first end window 3251, wherein the two light transmissive beam shaping elements 3250 are configured with the second end windows 3252 facing each other. Especially, the second optical filter element 2021 is configured between the two light transmissive beam shaping elements 3250. Hence, this beam shaping assembly 3240 may be configured between the first light transmissive body 1100 and the second light transmissive body 2100. The optical filter element 2021 may be comprised by one of the beam shaping elements 3250 or may be configured in between. In specific embodiments, the two light transmissive beam shaping elements 3250 are not physically coupled.

Hence, FIG. 5 schematically depicts two beam shaping elements configured between two luminescent concentrators and between a light source and a luminescent concentrator, respectively. In alternative embodiments, not depicted, two beam shaping elements may be configured between two luminescent concentrators with between each set of two luminescent concentrators a beam shaping element. Further, one or more light source may be configured to pump with light source light one or more light transmissive bodies of the respective luminescent concentrators. Therefore, a beam shaping assembly 3240 may be configured between the third light source 3010 and the first light transmissive body 1100 and/or wherein a beam shaping assembly 3240 may be configured between the first light transmissive body 1100 and the second light transmissive body 2100. The first end windows of the beam shaping assembly may essentially match with the (different) faces of the light transmissive elements. Hence, the beam shaping assembly may also be used to bridge light transmissive elements that have different dimensions faces (e.g. first face of a first light transmissive body and a second face of a second light transmissive body, like faces 1141 of light transmissive body 1100 and face 1142 of light transmissive body 2100 might e.g. be differently be dimension). By way of example, the optical filter element 1021,2021 are shown in different positions in the assemblies 3240. However, they may also be configured at similar positions, or in between (both sides air gap), etc.

FIG. 5 depicts an assembly of light transmissive bodies, beam shaping assemblies, and a third light source. However, any combination of two or more elements including at least a beam shaping assembly is considered part of the invention.

FIG. 6 schematically depicts an embodiment of the third light source, especially a red emitting solid state light source. The third light source 3010 comprises a light emitting surface 3015, such as a die. The die is comprised by a cavity, with a cavity wall 3026, which may be reflective, and a light transmissive window 3025, configured downstream of the light emitting surface 3015. The distance, indicated with reference d, may e.g. be in the range of about 10-1000 μm. It appeared that the intensity of the red emitting solid state light source can substantially be enhanced by having the light emitting surface 3015 being in contact with a light transmissive material. Hence, especially the light emitting surface 3015 is in physical contact with a light transmissive material 3020, such as a silicone, a silicone glue, a silicone gel, an optical fluid, etc.

The term “substantially” herein, such as in “substantially all light” or in “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. Where stated that an absorption, a reflection or a transmission should be a certain value or within a range of certain values these values are valid for the intended range of wavelengths. Such, if stated that the transmission of an elongated luminescent light transmissive body is above 99%/cm, that value of 99%/cm is valid for the converted light rays within the desired range of wavelengths emitted by the lighting device 1, while it would be clear to the person skilled in the art that the transmission of an elongated luminescent light transmissive body will be well below 99%/cm for the range of wavelengths emitted by the light sources 10, since the source light 11 is intended to excite the phosphor material in the elongated luminescent light transmissive bodies such that all the source light 11 preferably is absorbed by the elongated luminescent light transmissive bodies instead of highly transmitted.

The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

Practical designs may be further optimized the person skilled in the art using optical ray trace programs, such particular angles and sizes of microstructures (reflective microstructures or refractive microstructures) may be optimized depending on particular dimensions, compositions and positioning of the one or more elongated light transmissive bodies.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A lighting device wherein
a first light source, configured to provide first light source light, and a first light transmissive body are configured to provide first luminescent material light; a second light source, configured to provide second light source light, and a second light transmissive body are configured to provide second luminescent material light spectrally different from first luminescent material light, and a third light source is configured to provide third light source light spectrally different from the first luminescent material light and the second luminescent material light;
the third light source is configured upstream of the first light transmissive body, with the first light transmissive body being transmissive for at least part of the third light source light;
the first light transmissive body is configured upstream of the second light transmissive body, with the second light transmissive body being transmissive for at least part of the third light source light that is transmitted through the first light transmissive body and transmissive for at least part of the first luminescent material light; the second light transmissive body comprising a second radiation exit window configured to provide outcoupled light; and
one or more beam shaping assemblies, wherein the beam shaping assembly comprises two light transmissive beam shaping elements, each beam shaping element having a first end window and a second end window, larger than the first end window, with the beam shaping element tapering from the second end window to the first end window, wherein the two light transmissive beam shaping elements are configured with the second end windows facing each other, and wherein an optical filter element is configured between the two light transmissive beam shaping elements, wherein the optical filter element comprises a dichroic filter; wherein a beam shaping assembly comprising a first optical element is configured between the third light source and the first light transmissive body and/or wherein a beam shaping assembly comprising a second optical element is configured between the first light transmissive body and the second light transmissive body, wherein;
the first light source is configured to provide blue first light source light, and wherein the first light source and first light transmissive body are configured to provide first luminescent material light having an intensity in one or more of the green and yellow spectral part(s) of the visible spectrum;
the second light source is configured to provide second light source light having an intensity in one or more of the UV and blue spectral part(s) of the visible spectrum, and wherein the second light source and the second light transmissive body are configured to provide second luminescent material light having an intensity in the blue spectral part of the visible spectrum; and
the third light source is a solid state light source configured to provide third light source light having an intensity in the red spectral part of the visible spectrum, wherein;
the first optical filter element is configured downstream of the third light source and upstream of the first light transmissive body, wherein the first optical filter element is configured to transmit at least part of the third light source light and to reflect at least part of one or more of first light source light, first luminescent material light, second light source light, and second luminescent material light, and wherein;
the second optical filter element is configured downstream of the first light transmissive body and upstream of the second light transmissive body, wherein the second optical filter element is configured to transmit at least part of the third light source light and at least part of the first luminescent material light and to reflect at least part of one or more of the second light source light and the second luminescent material light.

2. The lighting device according to claim 1, wherein the lighting device is configured to provide lighting device light comprising the outcoupled light, wherein in a first mode of the lighting device the lighting device light comprises white light comprising at least part of the third light source light, at least part of the first luminescent material light, and at least part of the second luminescent material light.

3. The lighting device according to claim 1, further comprising a beam shaping optical element optically coupled with the second radiation exit window, configured to beam shape the outcoupled light.

4. The lighting device according to claim 1, wherein the third light source comprises a light emitting surface, wherein the light emitting surface is in physical contact with a light transmissive material.

5. The lighting device according to claim 1, wherein the first light transmissive body and the second light transmissive body are comprised by a single light transmissive body.

6. The lighting device according to claim 1, wherein the first light transmissive body and the second light transmissive body are different light transmissive bodies.

7. The lighting device according to claim 1, wherein the two light transmissive beam shaping elements are not physically coupled.

8. A spot lighting system comprising the lighting device according to claim 1.

9. An image projection system comprising the lighting device according to claim 1.
